(19) United States
(12) Patent Application Publication
(10) Pub. No.: US 2023/0169525 A1
(43) Pub. Date: Jun. 1, 2023

(54) SYSTEM AND METHOD FOR MANAGING A SALES CAMPAIGN

(71) Applicant: Renatus, LLC, Centerville, UT (US)

(72) Inventors: Bob Snyder, Centerville, UT (US); Eric Counts, Paragould, AR (US); Christopher Adam Cloud, II, Centerville, UT (US); J Stark, Centerville, UT (US); Todd Stewart Nichols, Centerville, UT (US)

(73) Assignee: Renatus, LLC, Centerville, UT (US)

(21) Appl. No.: 18/160,196

(22) Filed: Jan. 26, 2023

Related U.S. Application Data
(63) Continuation of application No. 17/216,636, filed on Mar. 29, 2021.
(60) Provisional application No. 63/001,454, filed on Mar. 29, 2020.

(51) Int. Cl. G06Q 30/0201; G06Q 30/0241; G06F 16/957; G06F 16/955; G06F 16/954; G06Q 30/0251

(52) U.S. Cl. CPC G06Q 30/0201; G06Q 30/0277; G06F 16/9577; G06F 16/955; G06F 16/954; G06Q 30/0251

(57) ABSTRACT

The invention includes embodiments of a system and method for managing a sales campaign. The system and methods disclosed herein are particularly useful in the context of an entity in the business of direct marketing and sales.

### CROSS-REFERENCE TO RELATED APPLICATIONS

This US non-provisional patent application is a continuation of U.S. patent application Ser. No. 17/216,636, filed on Mar. 29, 2021, and which claims benefit and priority to U.S. Provisional Patent Application No. 63/001,454 filed on Mar. 29, 2020, titled “SYSTEM AND METHOD FOR MANAGING A SALES CAMPAIGN”, the contents of which are incorporated by reference as if fully set forth herein.

### BACKGROUND OF THE INVENTION

### Field of the Invention

The present invention relates generally to systems and methods used to manage the creation, delivery and sales of goods and services. More particularly, this invention relates to systems and methods of managing a sales campaign for educational services.

### Description of Related Art

Direct marketing is a form of communicating an offer, where organizations communicate directly to a pre-selected customer and supply a method for a direct response. Among practitioners, it is also known as direct response marketing. By contrast, advertising is of a mass-message nature and not targeted to pre-selected customers.

Direct marketing often involves networking to build potential customers for the product or service offered by the company. Direct marketing further entails identifying customers from within that network who are most likely to be interested in purchasing the product or service offered by a company. Once candidate customers have been identified, the sales associate needs an effective means for communicating the offer of the product or service. There are many methods of communicating with candidate customers, such as email, text messaging, telephone calls and in-person meetings. However, these conventional tools alone make it difficult to maximize successful sales because they are typically separate channels of communication. Additionally, successful sales associates need to track their communications with candidate customers to obtain the desired sale.

Accordingly, there exists a need in the art for a method and system for better managing a sales campaign.

### BRIEF DESCRIPTION OF THE DRAWINGS

The following drawings illustrate exemplary embodiments for carrying out the invention. Like reference numerals refer to like parts in different views or embodiments of the present invention in the drawings.

The following drawings illustrate exemplary embodiments for carrying out the invention. Like reference numerals refer to like parts in different views or embodiments of the present invention in the drawings.

FIG. 1 is an embodiment of a home page for a system for managing a direct marketing business for offering real estate investment and wealth management training to customers, according to the present invention.

FIG. 2 is an embodiment of an education dashboard page for the system, according to the present invention.

FIG. 3 is an embodiment of a course library page for the system, according to the present invention.

FIG. 4 is an embodiment of a learning paths page for the system, according to the present invention.

FIG. 5 is an embodiment of a live education page for the system, according to the present invention.

FIG. 6 is an embodiment of an education documents page for the system, according to the present invention.

FIG. 7 is an embodiment of an instructors page for the system, according to the present invention.

FIG. 8 is an embodiment of a self assessments page for the system, according to the present invention.

FIG. 9 is an embodiment of a view on calendar tab within the high-level calendar events page for the system, according to the present invention.

FIG. 10 is an embodiment of a recorded events tab within the high-level calendar events page for the system, according to the present invention.

FIG. 11 is an embodiment of a calendar events page under a view all events tab for the system, according to the present invention.

FIG. 12 is an embodiment of a pending orders tab view page of the high-level orders feature for the HELIOS™ system, according to the present invention.

FIG. 13 is an embodiment of an order history tab view page from the high-level orders feature for the HELIOS™ system, according to the present invention.

FIG. 14 is an embodiment of a marketing dashboard page view under the high-level marketing feature for the HELIOS™ system, according to the present invention.

FIG. 15 is an embodiment of a “my day” page within the high-level marketing feature for the HELIOS™ system, according to the present invention.

FIG. 16 is an embodiment of a leads page within the high-level marketing feature for the HELIOS™ system, according to the present invention.

FIG. 17 is an embodiment of a team list view under the team page of the high-level marketing feature for the HELIOS™ system, according to the present invention.

FIG. 18 is an embodiment of a team tree view under the team page of the high-level marketing feature for the HELIOS™ system.

FIG. 19 is an embodiment of a paid to you page under the high-level marketing feature for the HELIOS™ system, according to the present invention.

FIG. 20 is an embodiment of a campaigns page for the system, according to the present invention.

FIG. 21 is an embodiment of a presentations page for the system, according to the present invention.

FIG. 22 is an embodiment of a video library page for the system, according to the present invention.

FIG. 23 is an embodiment of a training marketing 10-step page for the system, according to the present invention.

FIG. 24 is an embodiment of a training funding page for the system, according to the present invention.

FIG. 25 is an embodiment of a FAQ onboarding page for the system, according to the present invention.

FIG. 26 is an embodiment of a nationals page for the system, according to the present invention.

FIG. 27 is an embodiment of a training Renatus 10S page for the system, according to the present invention.

FIG. 28 is an embodiment of a training M.O.N.E.Y. matrix page for the system, according to the present invention.

FIG. 29 is an embodiment of a reports page for the system, according to the present invention.

FIG. 30 is an embodiment of a corporate documents page for the system, according to the present invention.

FIG. 31 is an embodiment of a control panel users page for the system, according to the present invention.

FIG. 32 is an embodiment of a control panel tools page for the system, according to the present invention.

FIG. 33 is an embodiment of a control panel roles page for the system, according to the present invention.

FIG. 34 is an embodiment of a control panel verifications page for the system, according to the present invention.

FIG. 35 is an embodiment of a control panel bonus pool page for the system, according to the present invention.

FIG. 36 is an embodiment of a control panel user payouts page for the system, according to the present invention.

FIG. 37 is an embodiment of a control panel event speakers page for the system, according to the present invention.

FIG. 38 is an embodiment of a control panel settings page for the system, according to the present invention.

FIG. 39 is an embodiment of a control panel nationals attendees page for the system, according to the present invention.

FIG. 40 is another embodiment of campaigns page for the system, according to the present invention.

FIG. 41 is an embodiment of campaign elements page for the system, according to the present invention.

FIG. 42 is an embodiment of a lead details page for the system, according to the present invention.

FIG. 43 is an embodiment of a campaign tab of lead details page for an exemplary lead for the system, according to the present invention.

FIG. 44 illustrates a block diagram of a combined hardware and software embodiment of the HELIOS™ system 500 for managing a sales campaign, according to the present invention.

FIG. 45 is a block diagram of a software embodiment of a system, according to the present invention.

FIG. 46 is a flowchart of a method of managing a sales campaign, according to the present invention.

### DETAILED DESCRIPTION

The invention is a method and system for better managing a sales campaign. The teachings of this invention can be used in any direct marketing and sales context and is not limited by the exemplary embodiments disclosed herein. One exemplary embodiment where the present invention has been applied is in the direct marketing of real estate investing and educational training services. A particularly useful feature built into embodiments of the present invention is the ability to give independent marketing affiliates access to sales campaigns. According to a particular embodiment, a sales campaign may include a private website for running the campaign and for directing sales leads.

RENATUS® LLC, (hereinafter “RENATUS®”) the applicant and assignee of the present invention, is a direct marketing company offering premier real estate investment education, participation in the real estate education, and application of this knowledge to gain confidence to successfully invest in real estate RENATUS® is headquartered in Centerville, Utah, United States. RENATUS® is a leader in providing comprehensive real estate investment education and providing additional tools and training to experienced investors to help them to reach their investing and financial goals. RENATUS® has developed its own comprehensive, proprietary curriculum based on the same scientific principles of Instructional System Design (ISO) used by universities across the country. RENATUS® instructors consist of hand-selected, experienced investors and educators who offer students the most unique, on-point experiential real estate education available.

In addition to the educational opportunities available to its student customers and clients, RENATUS® also offers students the opportunity to become Independent Training Affiliates (ITAs) authorized to provide RENATUS® training and/or Independent Marketing Affiliates (IMAs) authorized to sell RENATUS® products, namely RENATUS® branded real estate investing education opportunities. RENATUS® utilizes Independent Training Affiliates to develop and present real estate investing education to students of RENATUS® in live seminars and pre-recorded video presentations through its website, myrenatus.com. RENATUS® is a leader in providing comprehensive real estate investment education and providing additional tools and training to experienced investors to help them to reach their investing and financial goals. RENATUS® also utilizes Independent Marketing Affiliates to market and sell RENATUS® branded real estate investing education opportunities to pre-selected individuals through direct marketing. Not surprisingly, the sales of RENATUS® branded real estate investing education opportunities is paramount to the success of the company and its ITAs and IMAs.

RENATUS® has developed a comprehensive software system known as HELIOS™ that is used corporate-wide by the employees of the company and all of its licensed ITAs and IMAs in their daily interactions with RENATUS® and potential customers for RENATUS® brand products, e.g., individual or groups of real estate investment training seminars, etc. The embodiment of the invention referred to herein as HELIOS™, or HELIOS™ system, or simply “system”, is web-based software application package that provides RENATUS® brand real estate investment and other related training, via pre-recorded and live seminars provided by licensed ITAs to paid students of RENATUS®. However, there is much more functionality built into HELIOS™ as will be described in greater detail below.

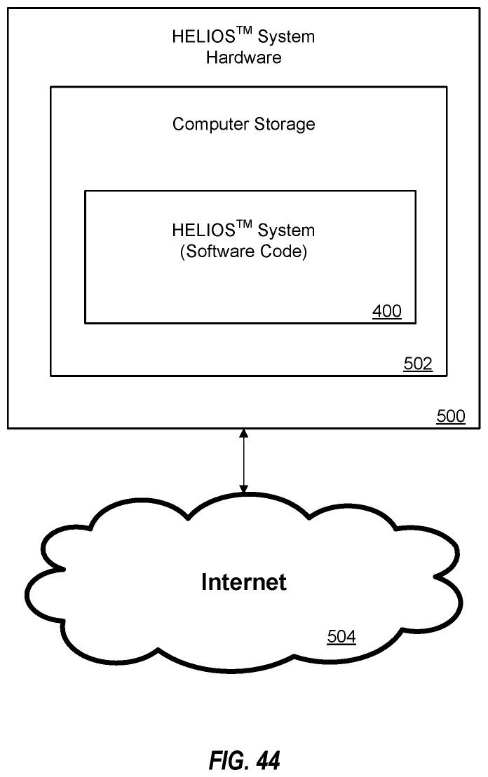

FIG. 44 illustrates a block diagram of a combined hardware and software embodiment of the HELIOS™ system 500 for managing a sales campaign, according to the present invention. System 500 may include computer hardware and related software coding for implementing a web server for hosting a website accessible to users through a computer network. The computer network may bed, for example and not by way of limitation, a local area network, a wide area network, a private Internet, a public Internet 504, etc., or some combination thereof. System 500 may also include computer storage 502 such as a hard disk drive, cloud storage, or any other suitable computer memory (not shown for simplicity of illustration) for storing and executing executable software code such as the HELIOS™ system software code 400, and data stored and manipulated by the system 400. It will also be understood that communication between system 500 and its users (not shown in FIG. 44) may be facilitated by conventional input/output devices such as keyboard, mice, touchpads and computer monitors, typically associated with computers of various kinds in proximity or remotely located and connected to a network such as Internet 504. Suitable off-the-shelf computer hardware and software development systems useful for implementing the present invention will be understood by one of ordinary skill in the art and, thus, will not be further elaborated herein.

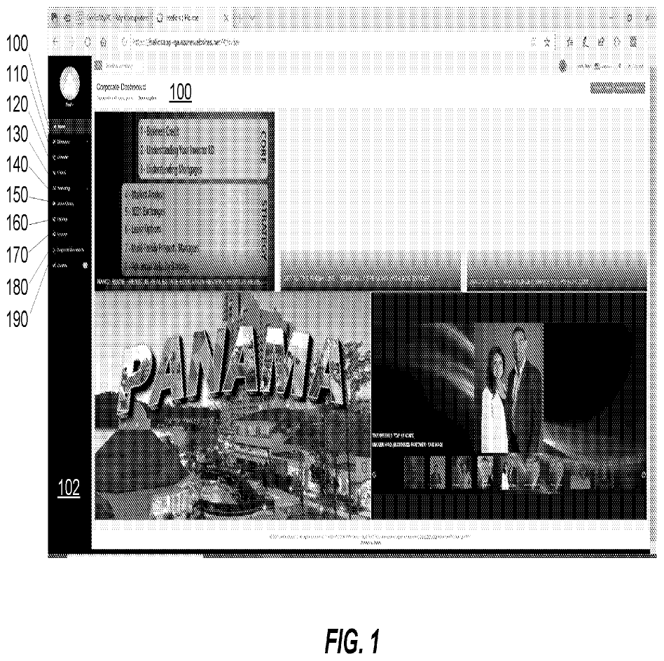

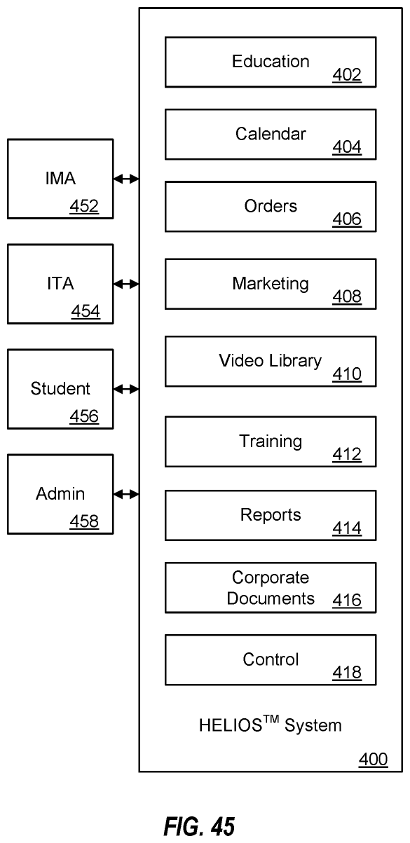

FIG. 45 is a block diagram of a software and user interface embodiment of a HELIOS™ system 400 for managing a sales campaign, according to the present invention. According to the illustrated embodiment, system 400 may include a website with a user interface for accessing features and functionality of system 400. For example, and not by way of limitation, see, FIGS. 1-43 and related discussion herein. According to one embodiment, system 400 may include a website with a homepage that directs users to a plurality of other webpages that implement the features and functionality of system 400. As shown in FIG. 45, an embodiment of system 400 may include webpages for education 402, calendar 404, orders 406, marketing 408, video library, 410, training, 412, reports 414, corporate documents 416 and control 418. System 400 may be accessed by a variety of users of the system 400. For example, users of system 400 may include one or more of the following types of users: an IMA 452, an independent training affiliate ITA 454, a student 456 or a system administrator (Admin) 458. It will be understood that other users of the system 400 may also be contemplated within the scope of the present invention. Having disclosed some general embodiments of the system and method for managing a sales campaign with reference to FIGS. 44 and 45, above, more specific embodiments will now be described with reference to FIGS. 1-43, below.

According to one embodiment, HELIOS™ may include a web-based user interface with high-level navigation tabs located along a left-side border of the user interface and content with controls located to the right and below. FIG. 1 is a screen-shot of an embodiment of a home or corporate dashboard page 100 used for displaying current events and information to users of the HELIOS™ system. The HELIOS™ home page 100 shown in FIG. 1 provides a convenient starting point for accessing other inventive features of the HELIOS™ system. This embodiment of a home page 100 may be the first user interface accessible to the user of HELIOS™ after logging into the system using a remote computer communicating through a network, such as the Internet. It will be understood by one of ordinary skill in the art that the particular layout of HELIOS™ home page 100 shown in FIG. 1, may be implemented many other ways with identical and similar features without departing from the scope of the present invention.

More particularly, the left side band 102 may be configured with tabs to access other features of the HELIOS™ system in the form of one or more separate web pages through hyperlinks or other navigation feature coding known to those of ordinary skill in the art. For example, and not by way of limitation, such other features of the HELIOS™ system may include home page 100 (as shown in FIG. 1), education page 110, calendar page 120, orders page 130, marketing page, 140, video library page 150, training page 160, reports page 170, corporate documents page 180 and control page 190. User location in the HELIOS™ system may be provided by highlighting a given feature page tab or by using a highlight bar adjacent to the selected tab, or both, according to various embodiments of the present invention, see, e.g., highlighting of “Home” and illuminated bar adjacent left to “Home” tab in FIG. 1. As shown in FIG. 1, other panes in the home page 100 may advertise current events, videos, and other media information to users of the HELIOS™ system.

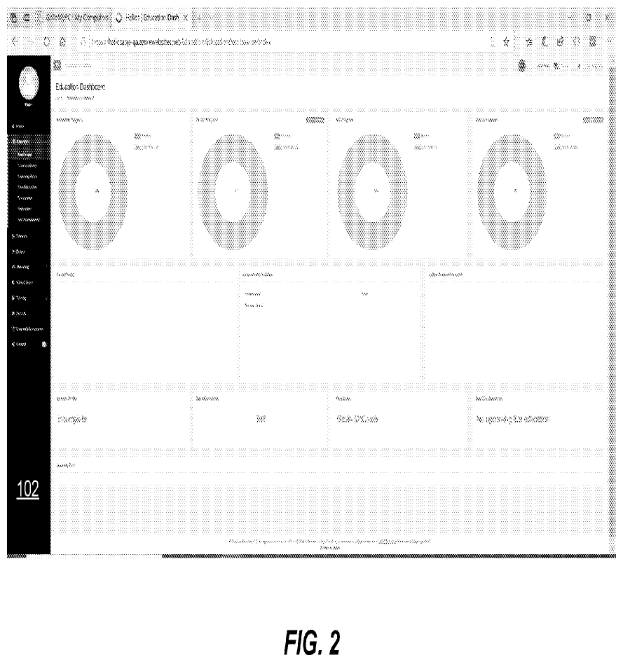

FIG. 2 is an embodiment of an education dashboard page 110 for the system, according to the present invention. According to one embodiment, HELIOS™ may further be configured with education features, e.g., a dashboard page that graphically displays progress in taking RENATUS® brand educational courses, notepads for taking notes during online instructional course viewing, windows for tracking assessments and quizzes, action steps and homework, see e.g., FIG. 2. The education dashboard page may be the first page displayed under the education high-level feature, see left border, FIG. 2.

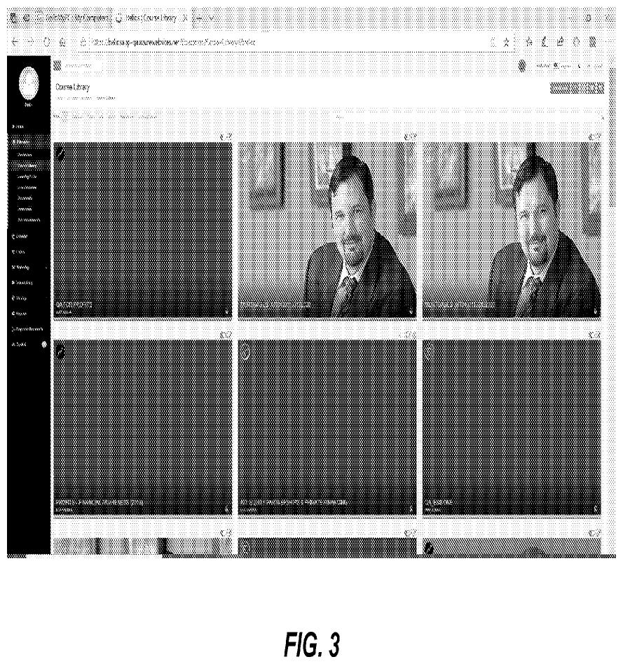

FIG. 3 is an embodiment of a course library page for the system, according to the present invention. According to another embodiment, HELIOS™ may further be configured with a course library page underneath the high-level education features. The course library page may include links for accessing RENATUS® brand educational courses online in multi-media, video format, see e.g., FIG. 3. The course library page may be the second page displayed under the education high-level feature, see left border, FIG. 3.

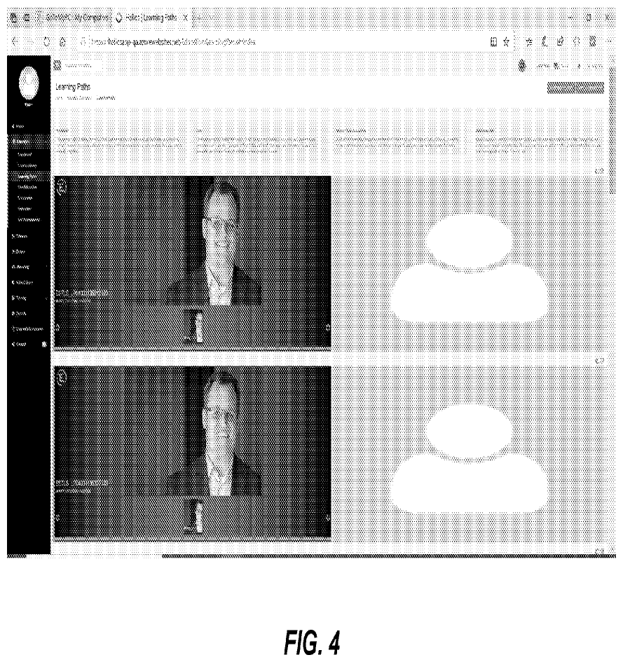

FIG. 4 is an embodiment of a learning paths page for the system, according to the present invention. According to yet another embodiment, HELIOS™ may further be configured with high-level education features including a learning paths page that describes suggested and required educational course sequencing and requirements for various levels of educational certifications, e.g., essentials, core, strategy specific and bonus courses, see e.g., FIG. 4. According to this embodiment, the learning paths page may be the third page displayed under the education high-level feature, see left border, FIG. 4.

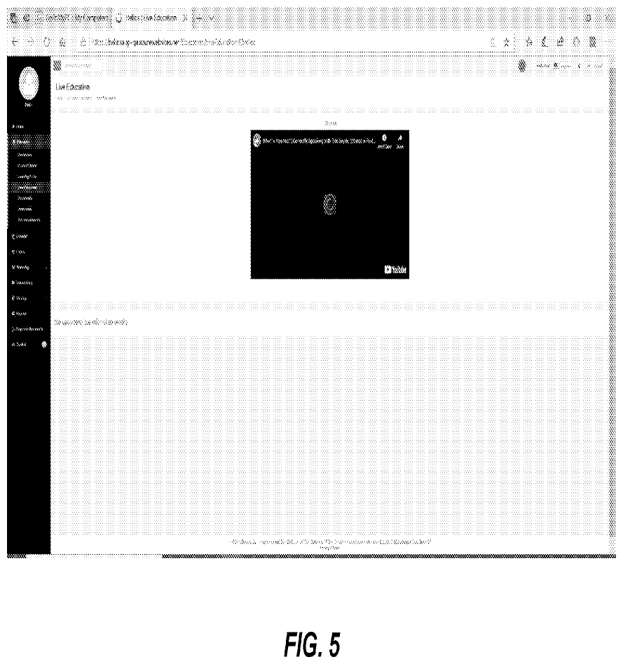

FIG. 5 is an embodiment of a live education page for the system, according to the present invention. According to still another embodiment, HELIOS™ may further be configured with high-level education features including a live education page for accessing live-streamed seminars scheduled for viewing at specific days and times, see e.g., FIG. 5. According to this embodiment, the live education page may be the fourth page displayed under the education high-level feature, see left border, FIG. 5.

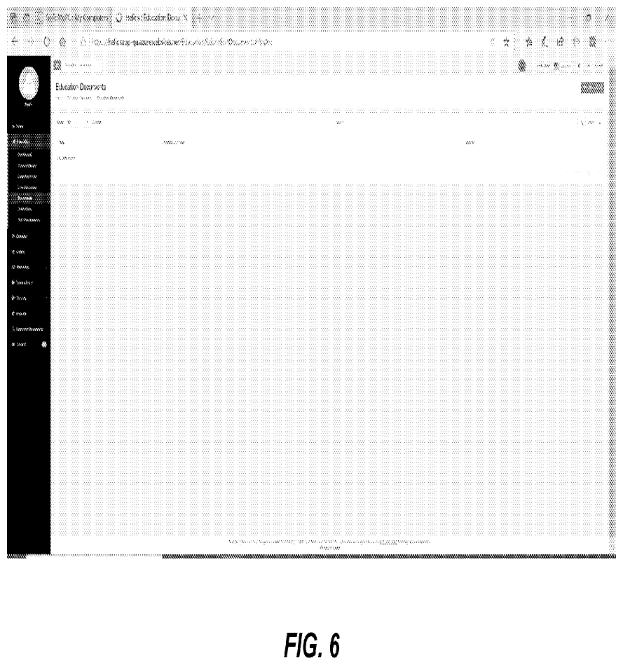

FIG. 6 is an embodiment of an education documents page for the system, according to the present invention. According to still yet another embodiment, HELIOS™ may further be configured with education features including a documents page that provides links to RENATUS® brand educational course documentation and other documents, as shown in FIG. 6. The education documents available through links may be in any suitable format and available for download or viewing only according various embodiments. According to this embodiment, the education documents page may be the fifth page displayed under the education high-level feature, see left border, FIG. 6.

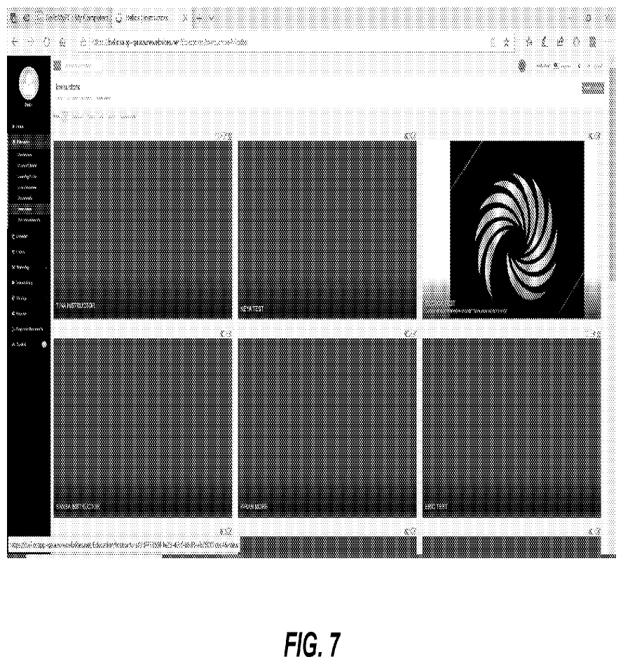

FIG. 7 is an embodiment of an instructors page for the system, according to the present invention. According to one embodiment, HELIOS™ may further be configured with high-level education features including an instructors page that provides biographies and other information about instructors for RENATUS® brand educational courses. According to this embodiment, the instructors page may be the sixth page displayed under the education high-level feature, see left border, FIG. 7.

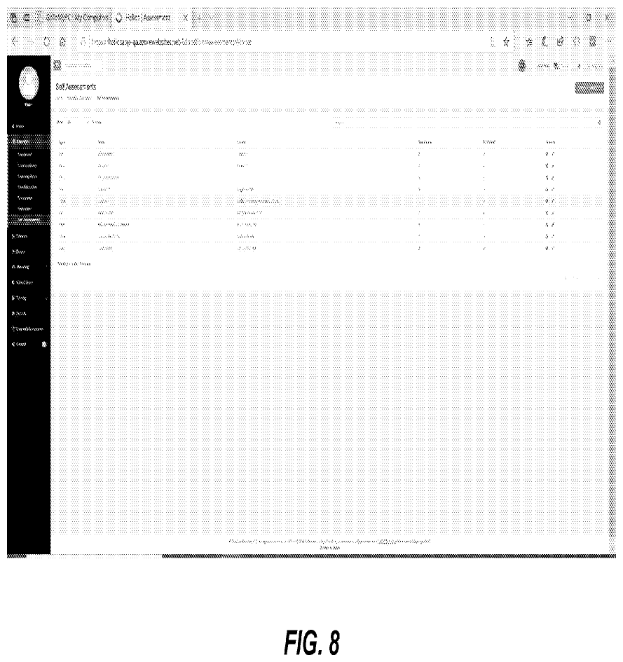

FIG. 8 is an embodiment of a self assessments page for the system, according to the present invention. According to another embodiment, HELIOS™ may further be configured with high-level education features including a self assessments page for assessing and tracking knowledge retention at various times during course instruction. According to this embodiment, the self assessments page may be the seventh page displayed under the education high-level feature, see left border, FIG. 8.

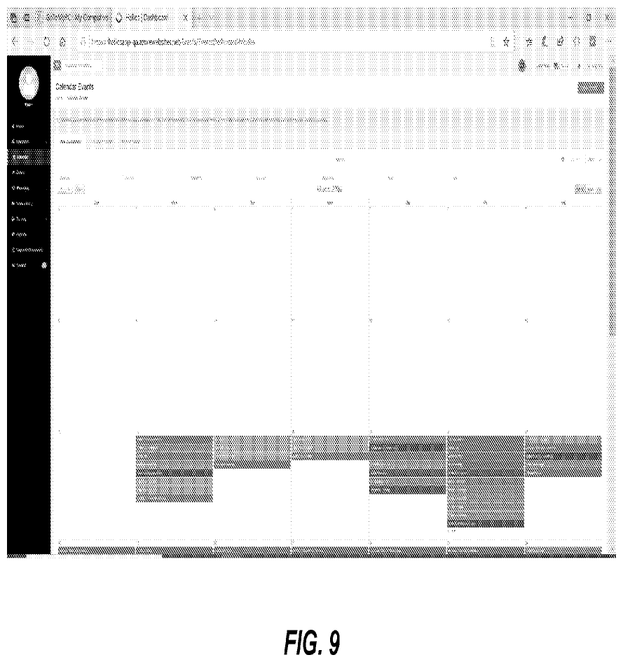

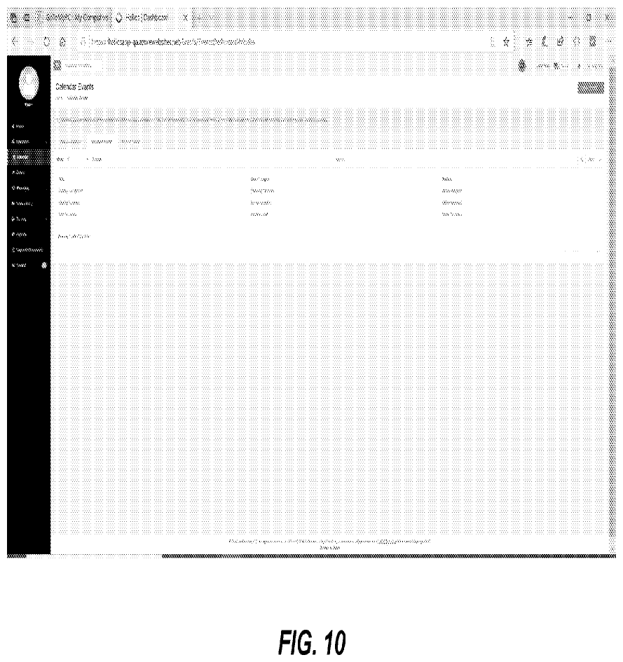

FIG. 9 is an embodiment of a view on calendar tab within the high-level calendar events page for the HELIOS™ system, according to the present invention. As shown in FIG. 9, the calendar events page may include multiple tabs across a near-top border, e.g., view on calendar (FIG. 9), recorded events (FIG. 10) and view all events, for various views of a user's calendar events. HELIOS™ may further be configured to graphically display any type of event that a user of HELIOS™ may be tracking.

FIG. 10 is an embodiment of a recorded events tab within the high-level calendar events page for the system, according to the present invention. As shown in FIG. 10, recorded events may be listed with a title, event category and medium type. In the recorded events tab view, only pre-recorded events are accessible to the user.

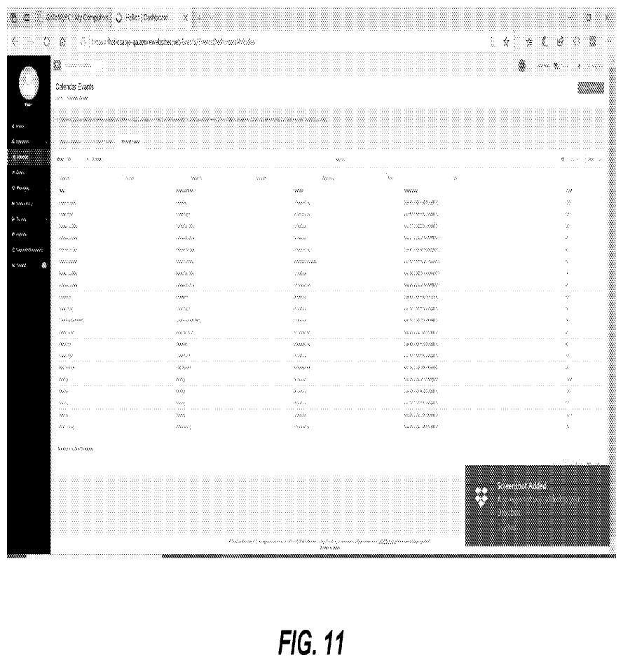

FIG. 11 is an embodiment of a calendar events page under a view all events tab for the HELIOS™ system, according to the present invention. In the view all events tab view, all events, not just pre-recorded events are accessible to the user. By clicking on one of the events, the user may obtain a full description of the event, who is hosting the event, registration fee timeline, registration fee, etc.

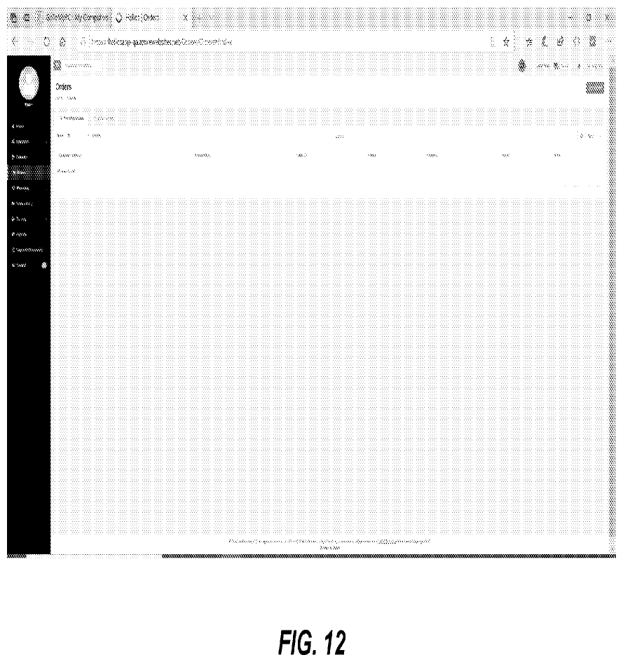

FIG. 12 is an embodiment of a pending orders tab view page of the high-level orders feature for the HELIOS™ system, according to the present invention. When a user clicks on the high-level orders feature (left border, FIG. 12), the pending orders tab view is displayed. According to this embodiment of the pending orders tab view, a user has a list view of orders (entries) that are identified with various fields including for example and not by way of limitation, “customer/sold by” which identifies who the customer is and who sold the pending product order. Another field may be “product/date” which identifies what RENATUS® brand educational course product being sold and the date of the transaction. Yet another field may be “order ID” which may be an internally assigned order number for tracking. Still other fields may for example and not by way of limitation include “status”, “progress”, “level” and “more”, for other means of classifying and identifying a given order associated with the user.

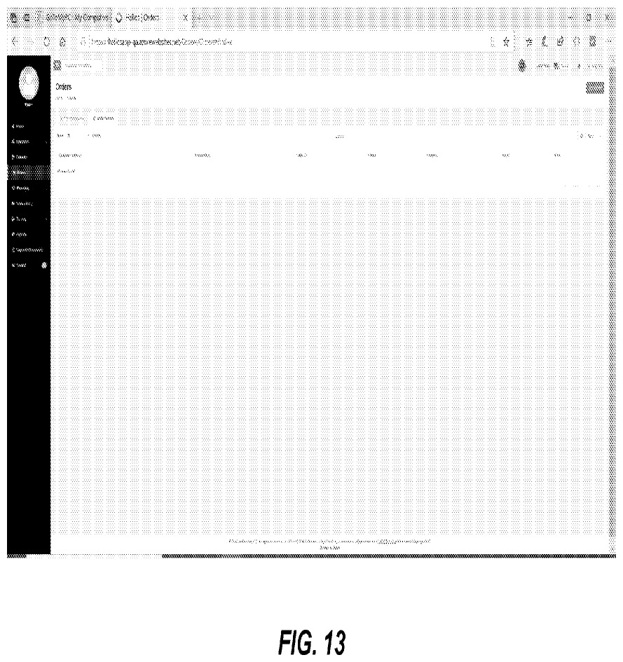

FIG. 13 is an embodiment of an order history tab view page from the high-level orders feature for the HELIOS™ system, according to the present invention. The order history tab view shows the same types of information as the pending orders tab but instead shows past orders as well.

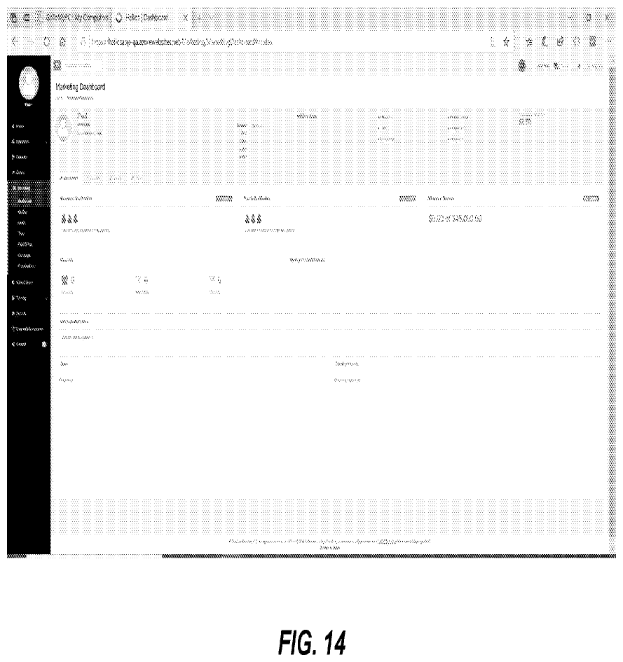

FIG. 14 is an embodiment of a marketing dashboard page view under the high-level marketing feature for the HELIOS™ system, according to the present invention. When a user clicks on the high-level marketing feature (left border, FIG. 14), a drop-down menu of marketing feature views is displayed, including “dashboard”, “my day”, “leads”, “teams”, “paid to you”, “campaign”, and “presentations”. By selecting the “dashboard” view, a “marketing dashboard” view is displayed. According to one embodiment, the marketing dashboard view provides a graphical display of a user's marketing performance and achievements. Some information may remain fixed under various tab views within the high-level marketing feature, for example and not by way of limitation, user attributes, affiliate team, star qualifications, login, task appointment status and amount paid to you fields. Whereas information in tabbed view below the fixed information may change depending on the tab view selected. According to the illustrated embodiment, the marketing dashboard page view may be further broken down by various tab views within the marketing dashboard feature, for example and not by way of limitation, “dashboard”, “activity”, “leads” and “team” tabs may each independently display information relating to those tabs.

By clicking on the “dashboard” tab (middle and just to the right of the left border, FIG. 14), the user can view whether the user has obtained “essentials qualification” or not and how many “essentials” courses need to be taken to achieve an essentials qualification. According to the embodiment illustrated in FIG. 14, a user may also view a tally of leads (“my leads”) they have and are pursuing, number of registrations and check-ins. Those “registrations/check-ins may also be listed below the tallies. “Leads by milestones” may be listed underneath the “registrations/check-ins” and finally “sales” may be listed at the bottom.

By clicking on the “activity” tab (middle and just to the right of the dashboard tab, FIG. 14), the user can view an activity list that keeps track of a user's logins by date and time. By clicking on the “leads” tab (middle and just to the right of the activity tab, FIG. 14), the user can view an ordered “lead list” with information about each lead. For example and not by way of limitation, the lead information may include fields for “name”, “email”, “phone”, “milestone” and “protected”. A user's leads are prospective customers of RENATUS® brand educational course products.

By clicking on the “team” tab (middle and just to the right of the leads tab, FIG. 14), the user can view an ordered list of the user's team members (“team list”) with various fields relating to each team member. For example and not by way of limitation, the team list information may include fields for “name”, “email”, “phone”, “qualifications”, “team” and “last login”. According to one embodiment, a user's team members may be anyone that a user has brought to the business as a sub-affiliate to sell RENATUS® brand educational course products for which the user gets a commission. The terms “team member” and “sub-affiliate” are used synonymously herein.

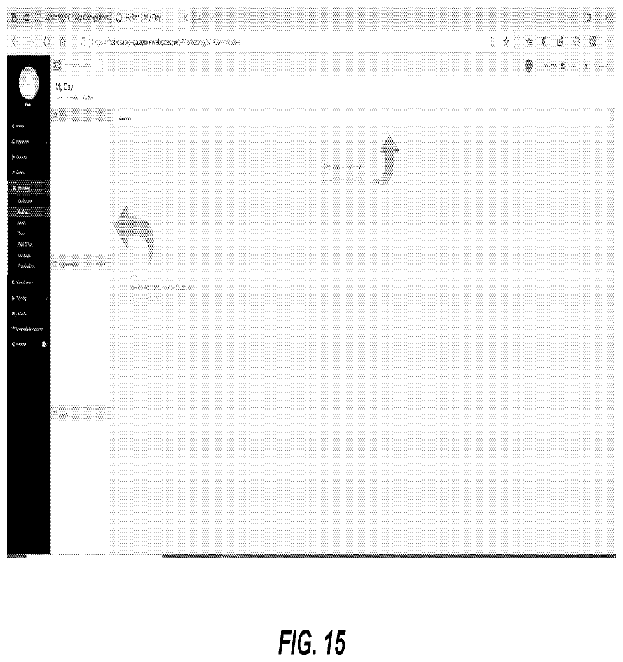

FIG. 15 is an embodiment of a “my day” page within the high-level marketing feature for the HELIOS™ system, according to the present invention. The “my day” page is a convenient place for a user to view tasks, appointments and events in list form (center, left, FIG. 15) and in calendar form (center, right, FIG. 15). According to the illustrated embodiment, a user can add and delete tasks, appointments, and events with various dependencies and information. This “my day” page provides a user/marketer pertinent information needed to focus on active leads. Tasks can be added manually, or more importantly, automatically, based on a leads progress through the campaign.

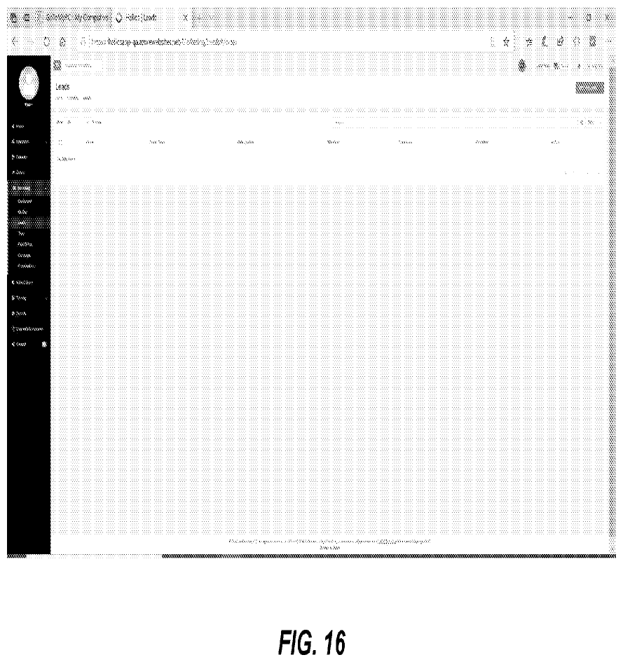

FIG. 16 is an embodiment of a leads page within the high-level marketing feature for the HELIOS™ system, according to the present invention. By clicking on the “leads” subheading under the high-level marketing feature (left border, FIG. 16), a user can see an ordered list of the user's leads and relevant fields associated with each lead. For example and not by way of limitation, the fields may include “name”, “email”, “phone”, “date created”, “milestone”, “exposures”, “protection”, and “action”. When a user want to add a new lead into the HELIOS™ system, the user clicks on the “add new lead” button (upper, right corner, FIG. 16) and will then be given a drop-down window of information to document a new lead, for example and not by way of limitation, name, email, phone, address, source of the lead, and importantly, a personal campaign website for the user to direct the user's lead for marketing purposes. The drop-down window provides a link to setup a “personal site name” for the campaign, or the user can select a campaign that is already up and running. Additional information and detailed description about the campaign feature is discussed below.

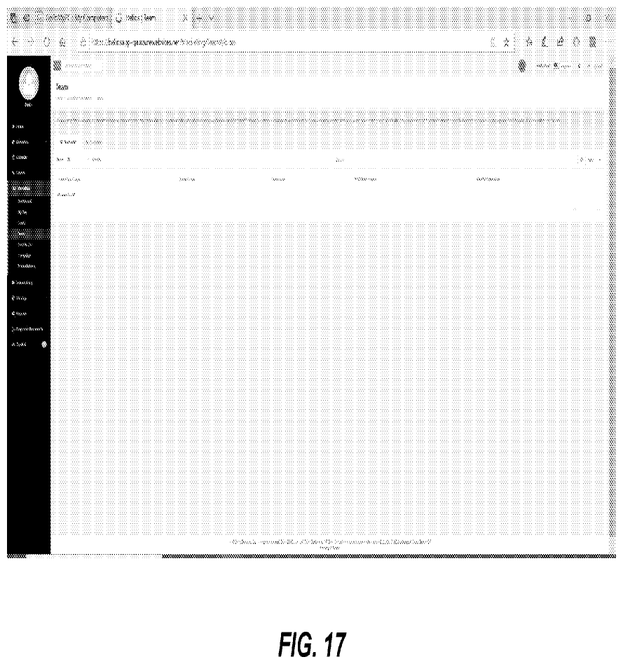

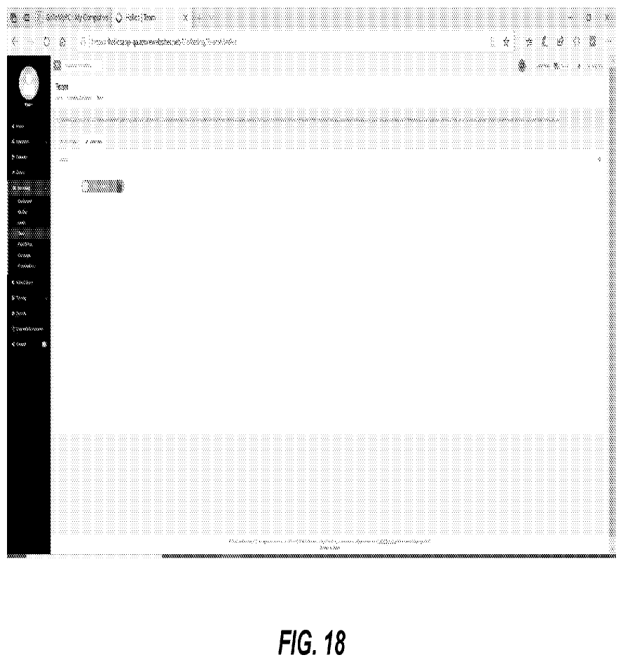

FIG. 17 is an embodiment of a team list view under the team page of the high-level marketing feature for the HELIOS™ system, according to the present invention. When a user clicks on the “team” subheading under the high-level marketing feature (left border, FIG. 17) the view defaults to a “team list” view as shown in FIG. 17 (left center tab). The “team tree” tab view is discussed below with reference to FIG. 18. The team list view provides a list of the user's team members, or sub-affiliates, and associated information about those team members. For example and not by way of limitation, the information for each team member may include the following fields: “name/qual/login”, “phone/email”, “team/leads”, “YTD/total income” and “Ess/AIT education”. By using this team list view a user can observe at a glance which of the team members is the top producer under the “YTD/total income” field and how far they have progressed in their education under the “Ess/AIT education” field.

FIG. 18 is an embodiment of a team tree view under the team page of the high-level marketing feature for the HELIOS™ system. The team tree view provides a graphical display of a user's team members in hierarchical tree form. The tern tree view includes all the same team members listed under the team list view shown in FIG. 17.

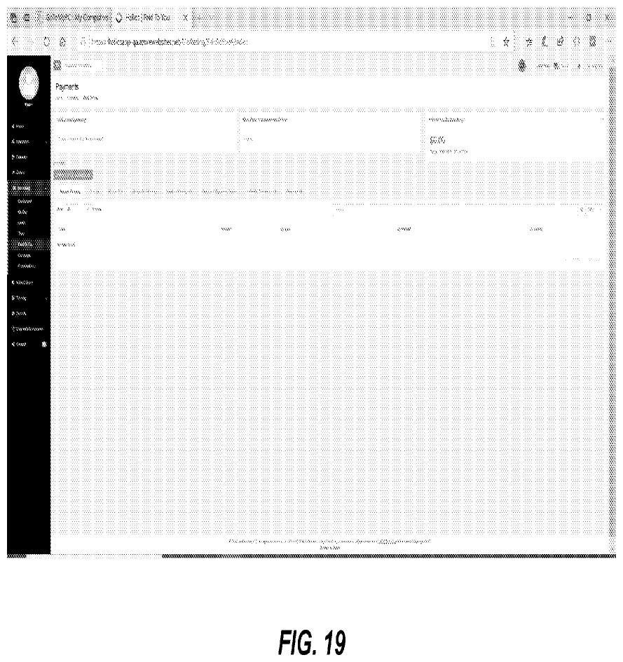

FIG. 19 is an embodiment of a paid to you (or payments) page under the high-level marketing feature for the HELIOS™ system, according to the present invention. This payments page is particularly useful to a user of the system as it transparently displays user sales commissions from various streams of income. When a user clicks on the “paid to you” subheading under the high-level marketing feature, the user can see at a glance the “total amount pending”, in commissions and “most recent amount paid to you” including a date. There is also a field to summarize commissions paid over a date range by using the “paid to you by date/range” sub-window. The “paid to you” page has a number of other information breakdowns that are related to payments to the user. According to the illustrated embodiment, there are tabbed views that show: “amount pending” on a dated per transaction basis, “history” of payments on a date per transaction basis, “bonus pool” which displays a total current pool amount and how it is disbursed to team members, “bonus pool history” which displays a total historical bonus pool payments paid to team members, “RENATUS® IOS payouts” which displays payments based on sales of the RENATUS® IOS product “RENATUS® IOS payouts history” which provides a listing of bonus payouts by date and amount and other special purposes payouts, for example and not by way of limitation, “calendar event payouts” and “OES payouts”.

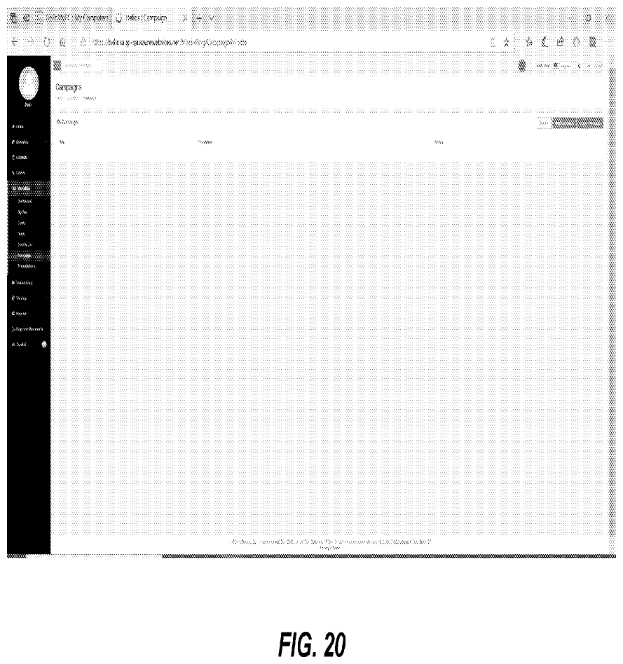

FIG. 20 is an embodiment of a campaigns page for the HELIOS™ system, according to the present invention. The embodiment of a campaigns page shown in FIG. 20 is what a new user might encounter before any campaigns have been added.

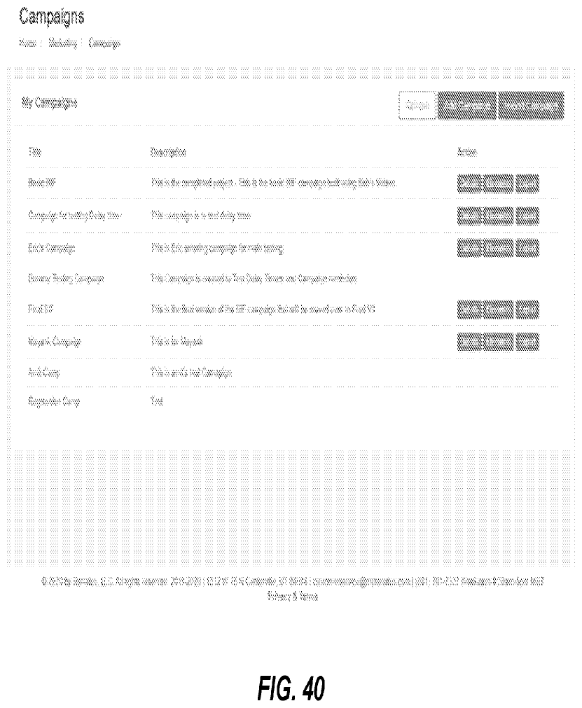

FIG. 40 is another embodiment of campaigns page for the HELIOS™ system, according to the present invention. As shown in FIG. 40, multiple campaigns are shown and each may have “action” buttons, i.e., “details”, “elements” and “export” for performing specific actions. This embodiment of a campaign page allows a user the ability to import, export, manage details and elements of a campaign based on the user's permissions.

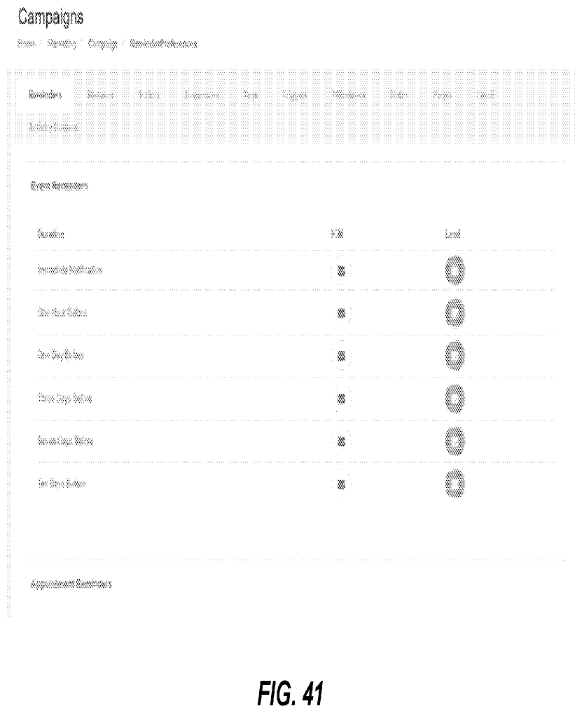

FIG. 41 is an embodiment of campaign elements page for the HELIOS™ system, according to the present invention. This campaign elements page allows a campaign designer the ability to add/edit the following elements of a campaign: Reminders, Statuses, Scripts, Sequences, Tags, Triggers, Milestones, Notes, Pages, Emails and Activity Buttons.

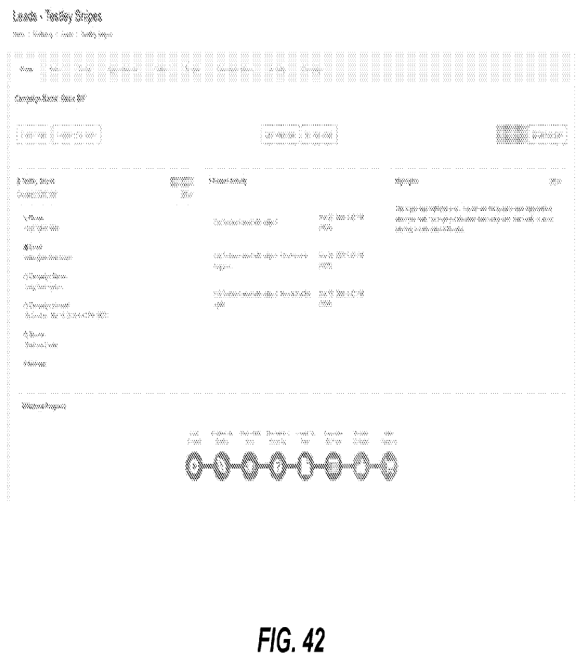

FIG. 42 is an embodiment of a lead details page for the HELIOS™ system, according to the present invention. This lead details page provides all of the information a user (marketer) needs to manage a sales lead, i.e., the target of a campaign. Features include: Notes, Tasks, Appointments, Orders, Scripts, Communications, Activity and Campaign specific details. Note the graphical Milestone Progress placed at the bottom of the lead details page (FIG. 42). This Milestone Progress graphic shows the lead's progress through the campaign. The goal of the IMA user is to encourage the lead to progress through all stages of the campaign, thus generating more sales.

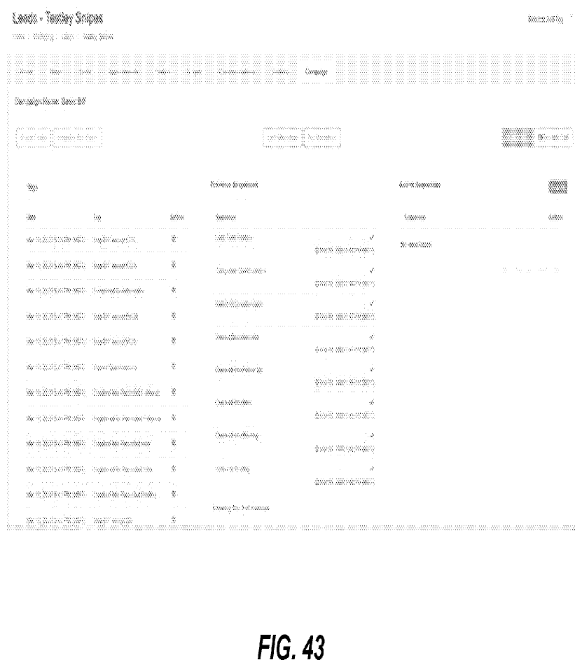

FIG. 43 is an embodiment of a campaign tab of lead details page for an exemplary lead for the HELIOS™ system, according to the present invention. From this page the user can check the status of this exemplary lead based on tags, previous sequences and active sequences. The user may also place and order for the lead or register the lead for an event, using buttons located on the upper left hand side of FIG. 43. The user may also have control buttons to indicate whether a voicemail was left or no voicemail was left (upper center buttons, FIG. 43). The user may also have control buttons to indicate not interested (“Not int”) or “do not call” based on feedback from the exemplary lead. As the campaign is an automated feature, it is also important to be able to turn off a given campaign, see the “Stop All” button, upper right side of FIG. 43.

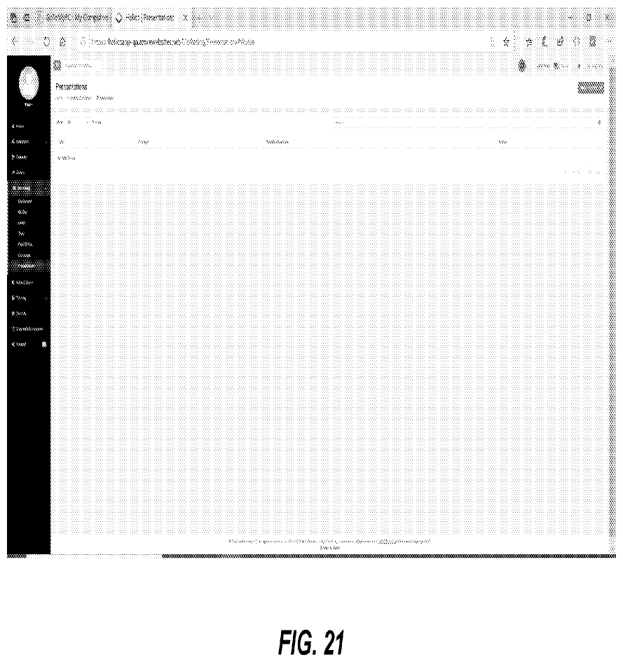

FIG. 21 is an embodiment of a presentations page for the HELIOS™ system, according to the present invention. From the presentations page, a user can access various presentations that may be listed with a title, file type, modification date and action fields.

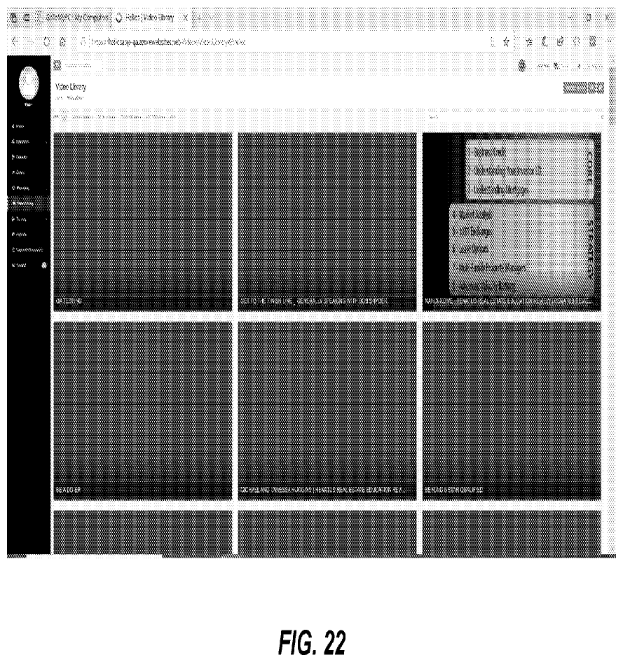

FIG. 22 is an embodiment of a video library page for the HELIOS™ system, according to the present invention. From the video library page, a user can access and view any of the videos that have been provided on the video library page for the user.

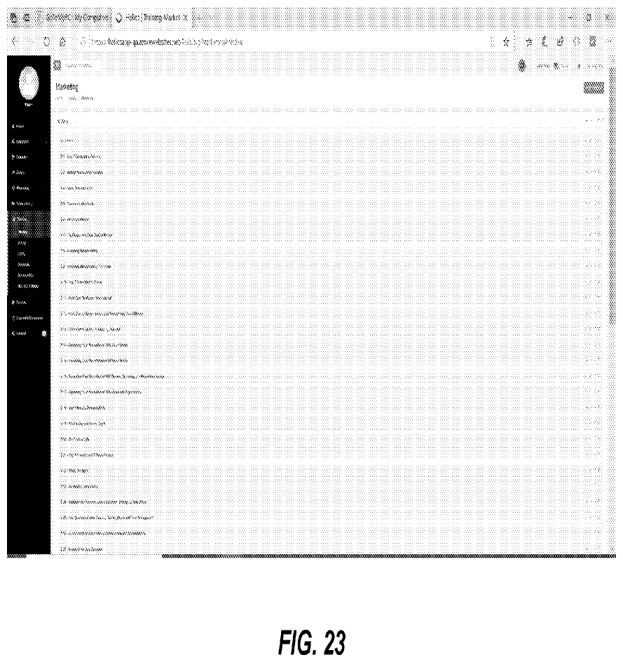

FIG. 23 is an embodiment of a training marketing 10-step page for the HELIOS™ system, according to the present invention. From the 10-step page, a user can walk through the preferred marketing steps promoted by RENATUS®. Each of the steps may include videos describing each step and what the user as an IMA is expected to do to be successful with RENATUS®.

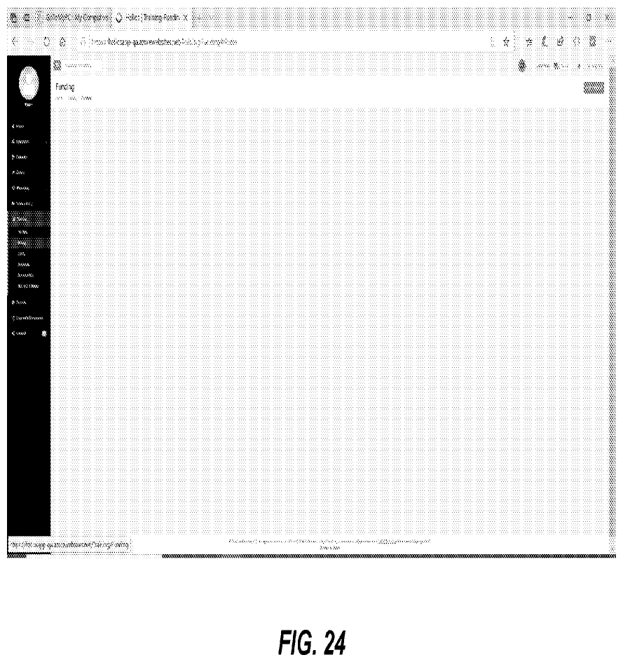

FIG. 24 is an embodiment of a training funding page for the HELIOS™ system, according to the present invention. According to this particular embodiment billing and funding functions may be tracked by a user.

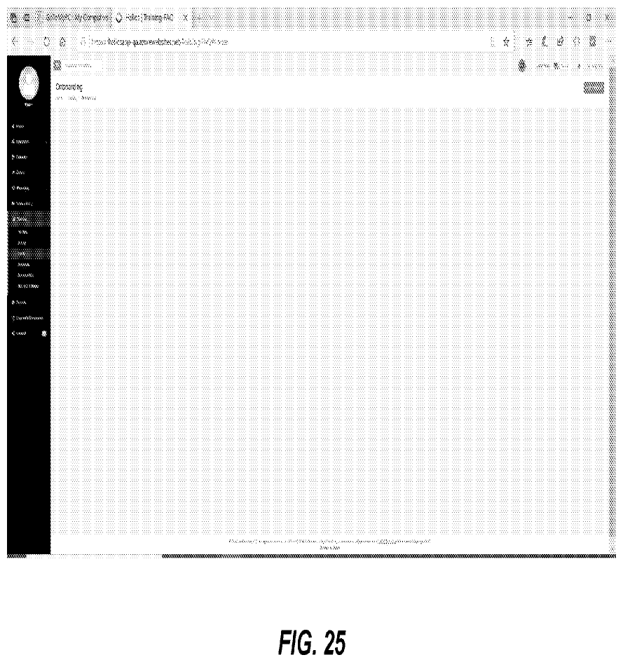

FIG. 25 is an embodiment of a FAQ onboarding page for the HELIOS™ system, according to the present invention. According to this particular embodiment of an onboarding page, frequently asked questions and answers are provided which may be useful to new users.

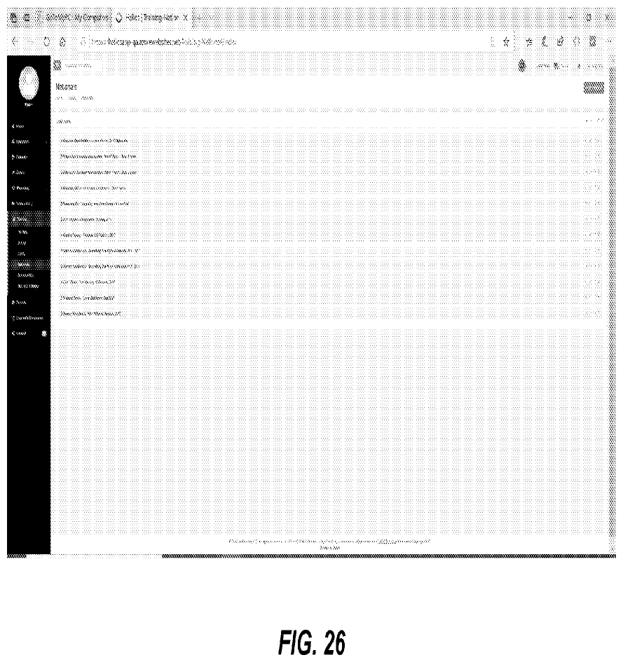

FIG. 26 is an embodiment of a nationals page for the HELIOS™ system, according to the present invention. Embodiments of a national page may include video recordings of previous nationals presentations where top performers are awarded in front of a live audience of their peers.

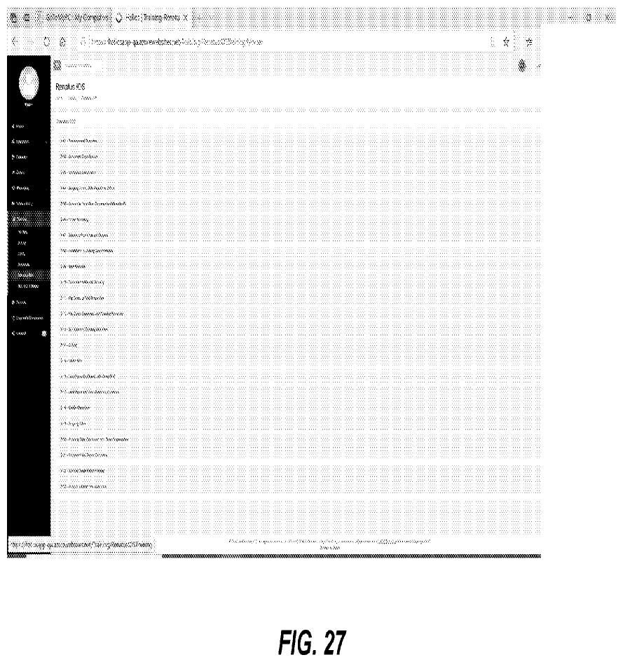

FIG. 27 is an embodiment of a training RENATUS® investment operating software (IOS) page for the HELIOS™ system, according to the present invention. According to one embodiment, the RENATUS® IOS page may include pertinent information regarding the RENATUS® IOS product.

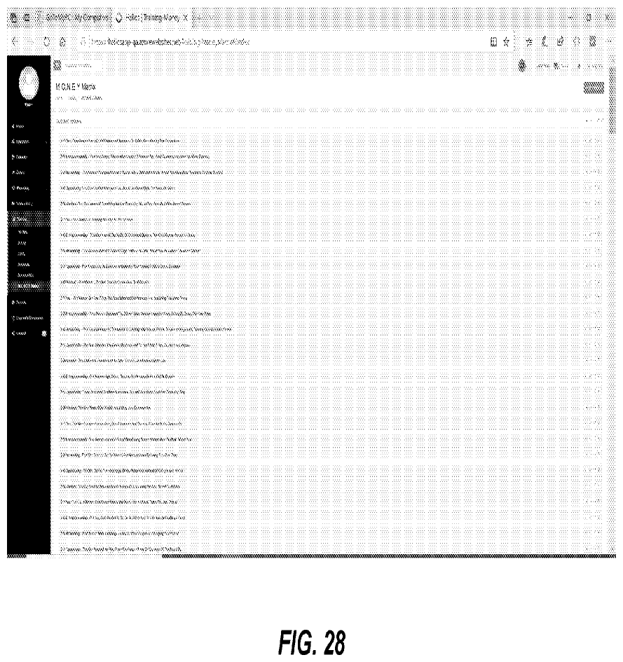

FIG. 28 is an embodiment of a training M.O.N.E.Y. matrix page for the HELIOS™ system, according to the present invention. M.O.N.E.Y is an acronym for Mindset, Opportunity, Networking, Entrepreneurship and You. The training M.O.N.E.Y. matrix page is a collection of inspirational videos that each tell a story. According to one embodiment, the M.O.N.E.Y. matrix page may include a collection of marketing stories in video format for motivating marketing sales personnel. Each video focuses on a particular person's mindset for success, the opportunities they took, the networking they did, their entrepreneurial spirit and the actions they took to overcome problems. The videos end with a call to action to think about how you can follow the example of the person highlighted and find success in your own life and business.

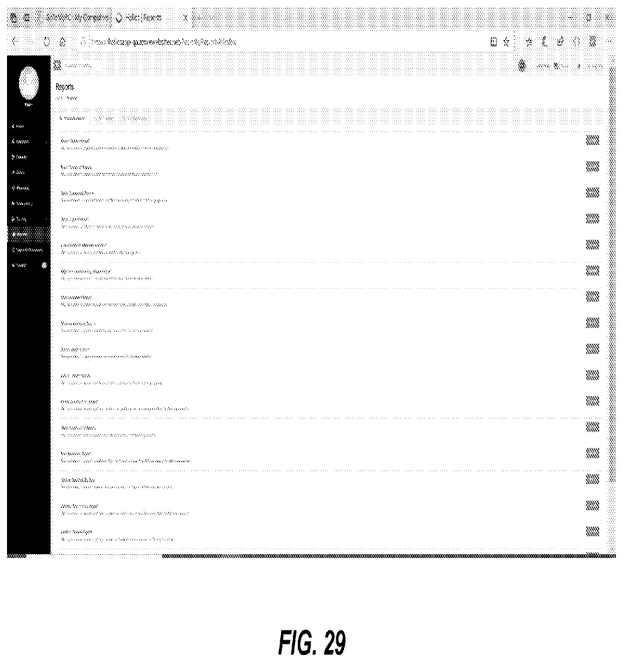

FIG. 29 is an embodiment of a reports page for the HELIOS™ system, according to the present invention. Embodiments of a reports page may be used to generate specifically enumerated reports, thereby reducing the task of manually generating same.

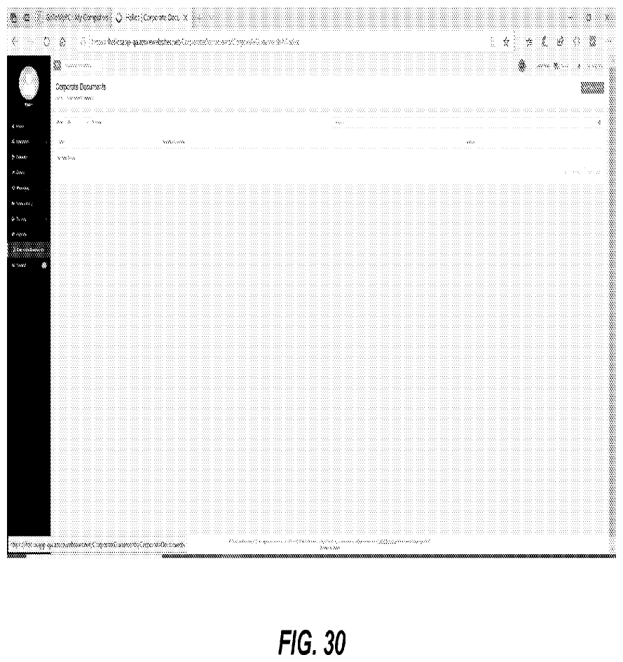

FIG. 30 is an embodiment of a corporate documents page for the HELIOS™ system, according to the present invention. According to various embodiments of a corporate documents page, a user may access documents pertinent to the business. The documents may listed with a title, modification date and action buttons for viewing, activating/deactivating, editing and deleting.

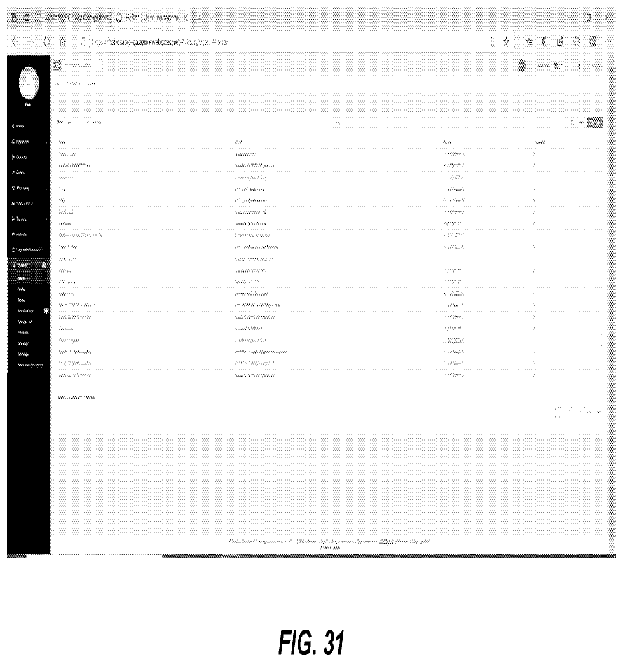

FIG. 31 is an embodiment of a control panel users page for the HELIOS™ system, according to the present invention. The users page provides a way of adding users to the system as well as removing them. According to various embodiments, the users page may list users of the system by name, email address, phone number and legacy ID number. By clicking on a particular entry in the list of users, the user's information will be displayed and various actions may be taken including reassigning, editing information, resetting password, locking, activities and activating/deactivating.

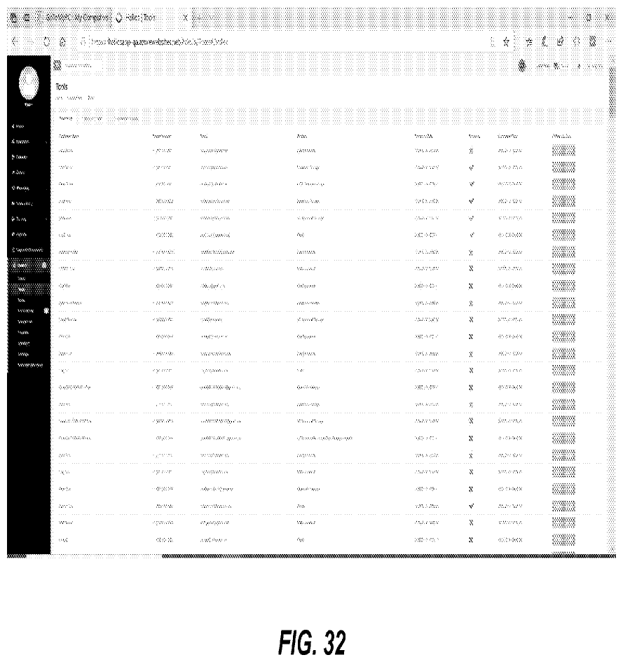

FIG. 32 is an embodiment of a control panel tools page for the HELIOS™ system, according to the present invention. According to various embodiments the user of the tools page may have access to a list of customers, each entry in the list including information such as customer name, phone number, email address, product purchased, date of purchase, financed or not, transaction completion date and follow-up call button.

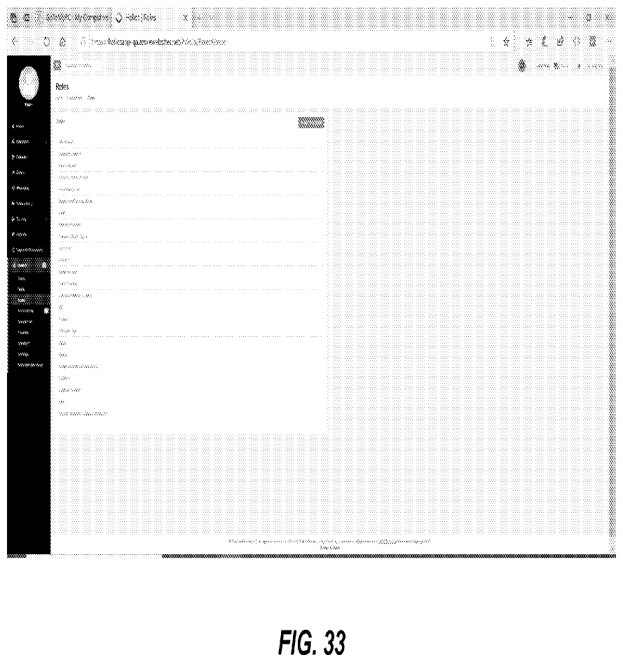

FIG. 33 is an embodiment of a control panel roles page for the HELIOS™ system, according to the present invention. According to the illustrated embodiment, the roles page may be used to add and delete roles within the company. These roles are assigned to users of the system.

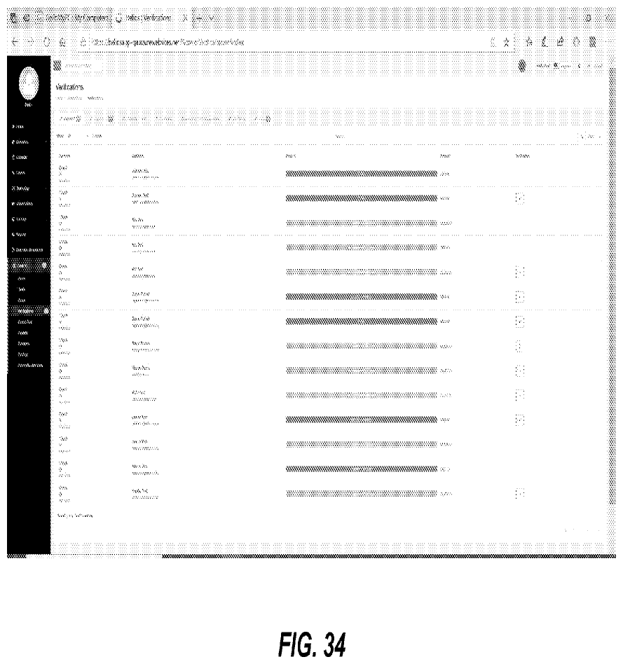

FIG. 34 is an embodiment of a control panel verifications page for the HELIOS™ system, according to the present invention. According to various embodiments, the verifications page allows a user to visually confirm financial transactions for sales of RENATUS® brand educational course products.

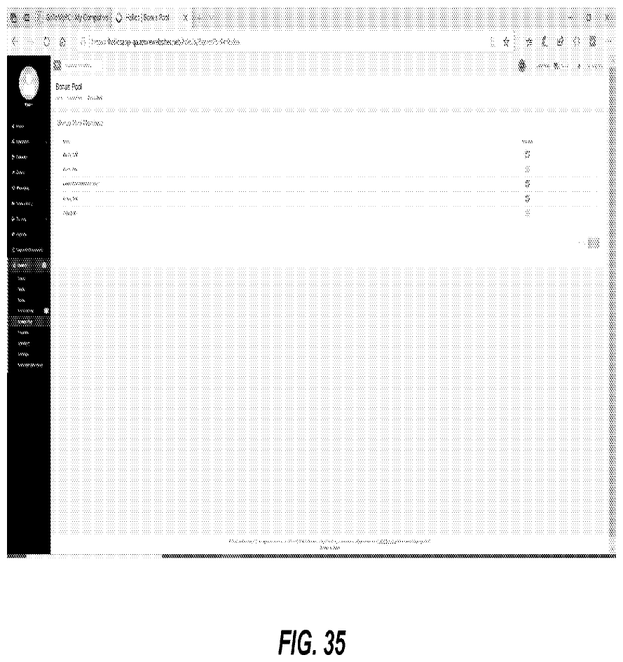

FIG. 35 is an embodiment of a control panel bonus pool page for the HELIOS™ system, according to the present invention. According to various embodiments, a control panel bonus pool page displays bonus pool members who are included in the bonus pool.

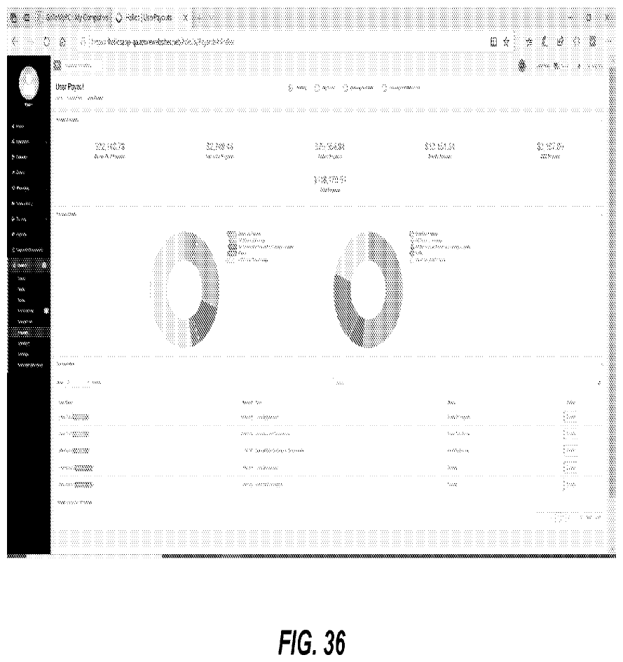

FIG. 36 is an embodiment of a control panel user payout page for the HELIOS™ system, according to the present invention. Embodiments of the user payout page will have a graphical display of monies earned from various possible income streams, i.e., bonus pool payouts, instructor payouts, orders payouts, event payouts as well as a total payouts summary.

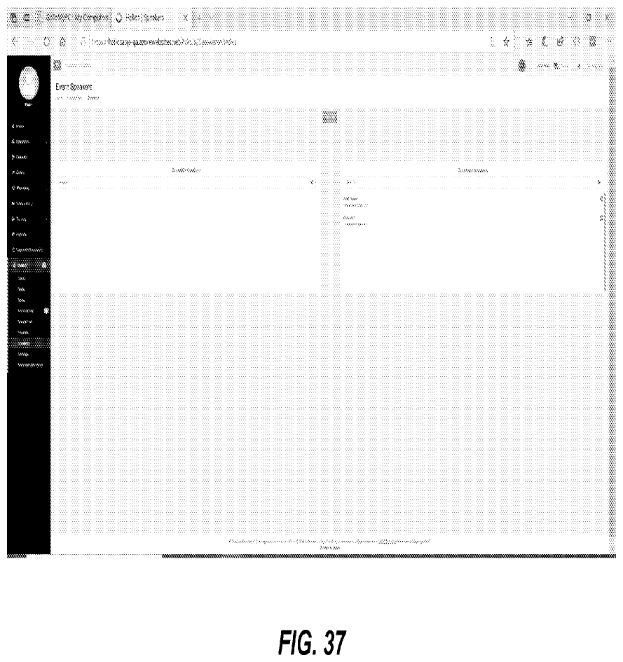

FIG. 37 is an embodiment of a control panel event speakers page for the HELIOS™ system, according to the present invention. The illustrated embodiment of an event speakers page may provide a listing of available speakers and approved speakers as well as the functionality to add an event speaker.

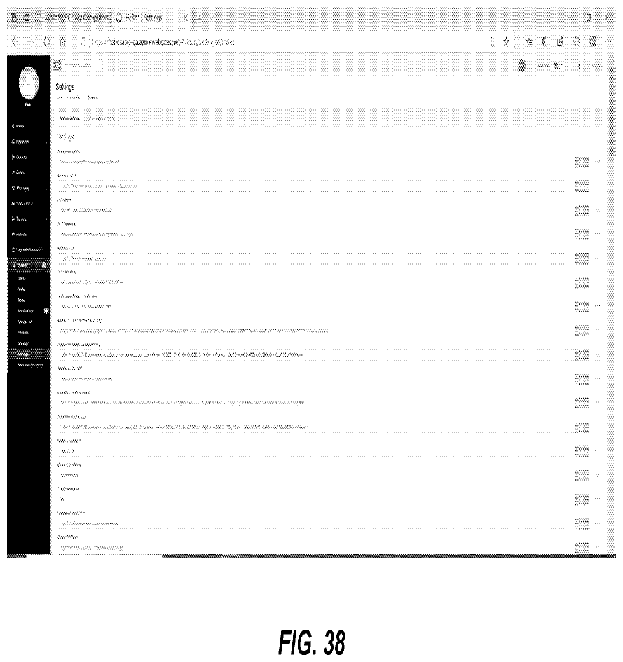

FIG. 38 is an embodiment of a control panel settings page for the HELIOS™ system, according to the present invention. The illustrated embodiment of a settings page gives a user with the appropriate access to system and application settings.

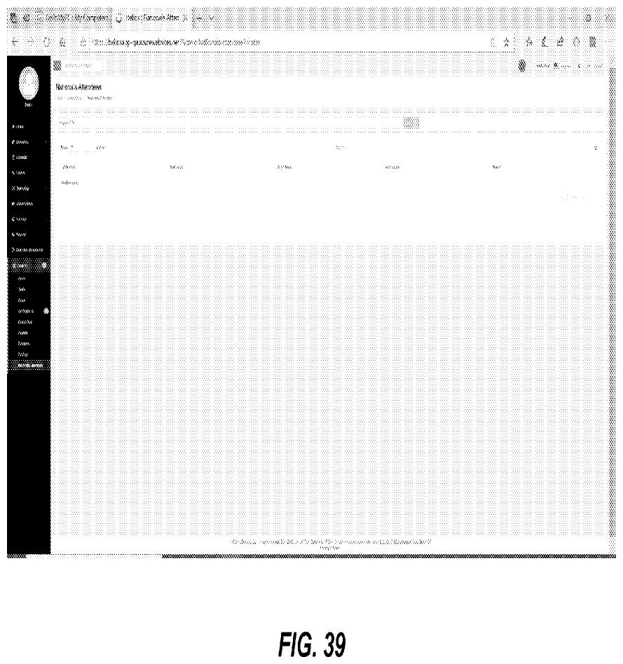

FIG. 39 is an embodiment of a control panel nationals attendees page for the HELIOS™ system, according to the present invention. The illustrated embodiment of a “nationals attendees” page provides a listing of attendees for the up-coming national conference. Each listing may include such informational fields as name, email, phone number, date added and action. A user with a sufficient level of access can add or delete nationals attendees.

HELIOS™ may further be configured with control features that can be used to register users of the system and assign roles to those users, e.g., student, business partner affiliate, ITA, IMA, coach, education manager, customer service agent, event host, instructor, media manager, etc. The control features include a verification feature that tracks customer payments for RENATUS® brand products. HELIOS™ further may include control features that can be used to track IMAs that fall within a bonus pool membership. HELIOS™ may further be configured with control features that can be used to summarize and display commissions from bonus pool payouts, instructor payouts, orders payouts, events payouts, etc. HELIOS™ may further be configured with control features that can be used to add and manage available and approved speakers for RENATUS® brand events. HELIOS™ may further be configured with control features that can be used to add and search attendees for national meetings conducted by RENATUS®.

Having described particular embodiments respect to FIGS. 1-43 and related discussion above, further general embodiments will now be described. The following general embodiments further expand upon the scope of the present invention and also overlap the specific embodiments already described.

An embodiment of a system for managing a sales campaign is disclosed. The system may include a server including computer storage configured to store computer code. The system may also be configured for hosting a website, according to a particular embodiment. The embodiment of a website may be configured with a user interface accessible via a computer network, according to one embodiment. The embodiment of a user interface may include a homepage configured to display a plurality of navigation tabs and a plurality of windows for displaying current events and messages associated with business activities of a direct marketing company. The embodiment of a homepage may further include a plurality of navigation tabs, wherein each tab may provide a hyperlink to one or more associated feature specific webpages, according to one embodiment. The one or more associated feature specific webpages further include webpages for product offerings, calendar, orders, marketing video library, training, reports corporate documents and system control.

According to another embodiment of the system, the product offering webpage may further include access to an education page for use by a user of the system. According to this embodiment, the education webpage may further include access to an education dashboard webpage configured for graphically illustrating a user's progress towards an education goal and profits progress. An embodiment of the education dashboard page may further include windows for storing and accessing recent notes, assessments and quizzes. The product offering webpage may further include access to a course library webpage configured to display windows for accessing pre-recorded educational training courses, sortable by pre-selected curricula. An embodiment of the education dashboard page may further include access to a learning paths webpage configured to describe the pre-selected curricula. An embodiment of the education dashboard page may further include access to a live education webpage configured to display real time instructional video streams to the user. An embodiment of the education dashboard page may further include access to a documents webpage configured to store and access course materials and certificates of completion for the user. An embodiment of the education dashboard page may further include access to an instructors webpage configured to display windows with information about course instructors. An embodiment of the education dashboard page may further include access to a self assessments webpage configured to display self assessments for the user in tabular format.

According to other embodiments of the system, the calendar webpage may further include graphical displays of: all events on a monthly calendar by time blocks, recorded events in table format and all events in table format. According to another embodiment of the system, the orders webpage may further include a graphical display of pending orders and order history, both in table format.

According to yet another embodiment of the system, the marketing webpage may further include a marketing dashboard webpage configured to graphically display marketing statistics of the user including training qualifications, profits qualifications, number of sales leads, number of training registrations, number of student check-ins, leads by milestone, sales and funding sources. According to still another embodiment of the system, the marketing webpage may further include a my day webpage configured for displaying a snapshot of a user's task list, appointments and events for a current day.

According to still another embodiment of the system, the marketing webpage may further include a leads webpage configured for displaying a table of user's sales leads including name, telephone number, email address, creation date, milestone, exposures, protection and action regarding each lead. According to another embodiment of the system, the marketing webpage may further include a team webpage configured for displaying a user's team in table or tree format.

According to another embodiment of the system, the marketing webpage may further include a paid to you webpage configured for displaying payments made to a user including total amount pending and most recent amount paid both in summary format, amount pending, history, bonus pool, bonus pool history and payouts from preselected products sold.

According to one embodiment of the system, the marketing webpage may further include a campaign webpage configured for displaying information regarding each of the user's campaigns, including title, description and action for each of the campaigns. According to yet another embodiment of the system, the marketing webpage may further include a presentations webpage configured for storing and accessing pre-recorded video or slide presentations at a user's disposal in table format. According to still another embodiment of the system, the video library webpage may further include windows for viewing pre-recorded video content relating to direct marketing and sales techniques.

According to an embodiment of the system, the training webpage may further include access to a 10-step webpage giving access to self-directed user training configured to provide the user advanced marketing and sales techniques to increase sales. According to one embodiment of the system, the training webpage may further include access to a billing webpage configured for tracking user sales of direct market products. According to another embodiment of the system, the training webpage may further include access to an onboarding webpage configured for providing access to frequently asked questions and answers for new users of the system.

According to another embodiment of the system, the training webpage may further include access to a nationals webpage configured for providing access to information including historical and annual achievements, lessons learned and special projects acknowledged at annual awards presentations for top performing users.

According to another embodiment of the system, the training webpage may further include access to a real estate investment webpage configured for providing a user manual for applications software further configured for generating contact information for motivated sellers, buyers and private lenders, generating and analyzing comparable property transactions for pricing, estimating repair costs for given properties and potential profit.

According to another embodiment of the system, the training webpage may further include access to a testimonials webpage configured with video presentations from successful real estate investors describing their mindset for success, the opportunities they took, the networking they did, their entrepreneurial spirit and the actions they took to overcome problems.

According to yet another embodiment of the system, the reports webpage may further include access to a listing of reports summarizing one or more of the following aspects of events: event created, event occurred, order completed, order signed, live education attendance, rejected customer signatures, classes viewed, webinar attendees, winner circle, active viewers, direct qualification, team qualification, non-renewed, ⅕ star qualified by date, national conference and leaders retreat. According to yet another embodiment of the system, the corporate documents webpage may further include a listing of corporate documents for access by the user.

According to other embodiments of the system, the control webpage may further provide access to one or more additional webpages. For example, and not by way of limitation, the control webpage may further provide access to a users webpage configured to provide a list of system users each system user listed with name, email address and phone number in table format. According to one embodiment, the control webpage may further provide access to a tools webpage configured with a table of customers, each entry in the table including information such as customer name, phone number, email address, product purchased, date of purchase, financed or not, transaction completion date and follow-up call button. According to another embodiment, the control webpage may further provide access to a roles webpage configured for an administrator of the system to add and delete roles for each user within the system. According to yet another embodiment, the control webpage may further provide access to a bonus pool webpage configured for displaying bonus pool members who are included in the bonus pool. According to yet another embodiment, the control webpage may further provide access to a user payout webpage configured for displaying payments made to the user based on: bonus pool, instructor courses taught, products ordered and total payments. According to still another embodiment, the control webpage may further provide access to an event speakers webpage configured for listing speakers available for speaking at events arranged and scheduled by the user. According to one embodiment, the control webpage may further provide access to a setting webpage configured for a user or system administrator to set and adjust system setting and application settings. According to still yet another embodiment, the control webpage may further provide access to a nationals attendees webpage configured for listing attendees for the national awards conference.

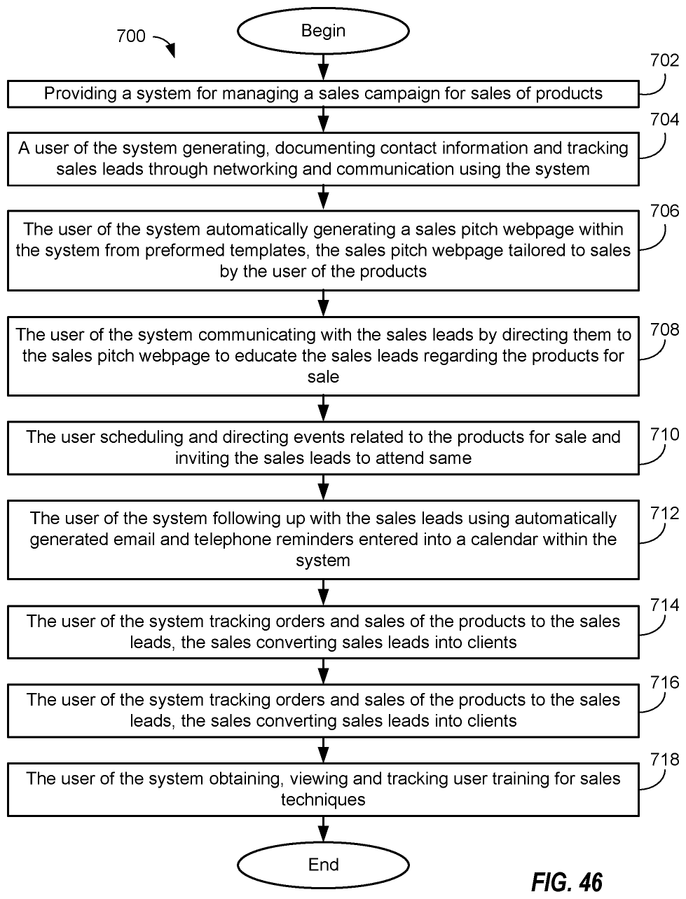

Referring now to FIG. 46, an embodiment of a method 700 for managing a sales campaign, the method is disclosed. Method 700 may include the step of providing 702 a system for managing a sales campaign for sales of products. It will be understood that the products may be any goods or services, not just the exemplary real estate investment training described herein. Method 700 may further include the steps of a user of the system generating, documenting contact information and tracking 704 sales leads through networking and communication using the system. Method 700 may further include the step of the user of the system automatically generating 706 a sales pitch webpage within the system from preformed templates, the sales pitch webpage tailored to sales by the user of the products. Method 700 may further include the step of the user of the system communicating 708 with the sales leads by directing them to the sales pitch webpage to educate the sales leads regarding the products for sale. Method 700 may further include the step of the user scheduling and directing 710 events related to the products for sale and inviting the sales leads to attend same. Method 700 may further include the step of the user of the system following up 712 with the sales leads using automatically generated email and telephone reminders entered into a calendar within the system. Method 700 may further include the step of the user of the system tracking 714 orders and sales of the products to the sales leads, the sales converting sales leads into clients. Method 700 may further include the steps of the user of the system obtaining, viewing and tracking 718 user training for sales techniques. According to another embodiment of method 700, the system for managing a sales campaign may further include a server including computer storage with computer code configured for hosting a website, the website configured with a user interface accessible via a computer network and the user interface including a homepage configured to display a plurality of navigation tabs and a plurality of windows for displaying current events and messages associated with business activities of a direct marketing company, the plurality of navigation tabs each providing a hyperlink to one or more associated feature specific webpages, such as those disclosed herein.

Having described some general embodiments the HELIOS™ system, further description of the HELIOS™ lead generation funnel and campaign features are provided below. To better understand the functionality of the HELIOS™ system and how the lead generation and sales campaign feature operates, it will be explained using four different perspectives: administrator, ICM, potential customer (sales lead) and third-party API user.

From an administrator perspective, the HELIOS™ system is used to setup and run a corporate campaign. The corporate campaign follows a Briefing/Intro/Follow-up (BIF) pattern. Each webpage contains a video, sharing information with the sales lead as the lead progresses to the end. Each webpage is also associated with an event on the Helios Event Calendar for the purpose of setting protection. During the process, the following mechanisms are used to track lead activity and assist the ICM while working with the lead.
1. Statuses. The administrator can create/edit statuses which will be applied to a lead record based on the lead meeting a designated criteria.
11. Scripts. The administrator can create/edit scripts to be used by ICMs as they interact with leads.
111. Sequences. The administrator can create/edit sequences which send emails, create tasks, update status, do HTTP posts, add and remove tags and add notes. Many of these actions are visible to the ICM on a lead's Lead Details page.
1v. Tags. Items the administrator uses to control the flow of the Corporate Campaign.
v. Milestones. The administrator can create/edit campaign milestones the lead will reach and define what actions are taken when the milestones are met. The ICM can view a lead's progress in the campaign by viewing the milestones on the Lead Details page.
v1. Notes. The administrator can create/edit notes which are associated with a lead's account based on criteria set in the other campaign elements.
v11. Activity Buttons. The administrator can create/edit activity buttons which are available to the ICM on the Lead Details page for a lead. The ICM is able to select an activity button to execute an action defined by the administrator.

Lead funnels are used to generate sales leads. Products may then be associated with a selected funnel which will allow the sales lead the ability to purchase one or more products directly from the funnel. It will be understood that various types of funnels may be used with the HELIOS™ system, for example and not by way of limitation: summit, lead magnet and reverse sales.

A summit funnel is an event where sales leads are generated by putting together an online summit with multiple speakers that are interviewed. Summit funnels are the perfect way for entrepreneurs to provide value and become more of an authority figure in their industry. The interviewer allows potential clients to register for the summit for free, with the opportunity to potentially upsell the attendees on product offerings. The summit funnel is a great way to build a list of sales leads and brand your authority. The invitation to attend a summit funnel may include, for example, a biography of each person presenting with their headshot on the registration page. An upsell may include, for example offering the recordings of the event and using a share webpage or link to invite friends and other acquaintances to the event.

A lead magnet funnel is the offering of something of value after receiving a sales lead's contact information, for example, their email address. The something of value may be a report or video or physical item.

A reverse sales funnel, is the offering of something of value up front and then asking for the sales lead's contact information. For example, in a reverse sales funnel, you might give away some of your best information and/or items before asking for a potential customer or sales lead to opt-in. Then you simply ask the potential customers to “opt-in for more” after they view your pitch, sales video, etc. The reverse sales funnel is helpful when you need to drop your customer's walls quickly since you have already contributed to your ‘relationship’ with them. The reverse sales funnel may have a lower conversion rate than other funnels, but the quality of the leads tends to be higher. A thank you webpage may be used to give more information and share with their friends.

The Reminders is a tab may be found on the Marketing>SalesLinks>Campaign>Corporate Campaign-Elements page. According to one embodiment, reminder templates for events on the Helios Event Calendar can be edited here and may be sent to all ICMs and Leads who meet the criteria, regardless if the lead is part of a campaign.

Triggers are actions that occur based on a particular condition being met. There are at least two types of triggers that may be used in the HELIOS™ system, for example and not by way of limitation: system and event. System triggers may be fired by the HELIOS™ system. For example, when an ICM needs to renew, a system event is triggered. This allows the campaign administrator to send an email to all ICMs who need to renew automatically when it is time for the ICMs to renew. Event triggers may be fired by the HELIOS™ system for events on the Event Calendar by type.

From an ICM perspective, the HELIOS™ system is used to setup and run a product sales campaign. ICMs are provided a means to request a personalized website or uniform resource locator (URL) which is subject to approval from the HELIOS™ system administrator. This gives the ICM a corporate sponsored webpage within the HELIOS™ system for promoting corporate products for sale. Once a campaign or funnel is approved and live, the ICM can navigate to the Marketing>Sales Links webpage and obtain a personalized link to the desired campaign or funnel. The ICM can copy and share the link in email, text, social media, etc. The link is generally simple enough that it can also be shared on a standard business card. As a sales lead navigates through the webpages of a funnel or campaign, the lead activity may be recorded on the Marketing>Leads>Lead Details page. Activity notifications are also sent to the ICM in Web and/or Mobile versions of the HELIOS™ system. ICMs may also have access to sales lead scripts. Scripts may be created by the campaign administrator and made available to the ICM when interacting with the lead on the Lead Details webpage. Any emails sent to a lead using the campaign sequence can be viewed by the ICM on the Lead Details page under Communication webpage.

An important aspect of any direct marketing operation is protection of leads. So, it is also important to view the HELIOS™ system from a lead perspective. According one embodiment of the HELIOS™ system, leads may be automatically created and protected to an ICM when they enter the system through a personalized funnel or campaign link. If the lead already exists in the system and is protected by another ICM, the protection stays the same and does not change to the owner of the personalized link.

Another useful aspect of the HELIOS™ system is frequent and timely notification. As a lead progresses through a funnel or campaign, the lead may receive email notifications when making purchases. The lead may also receive email notifications through a nurturing sequence if the lead does not make an initial purchase.

Third party application programming interface (API) users may also use the HELIOS™ system to manage a sales campaign. This feature may be useful in a context where a sales campaign was created outside of the HELIOS™ system, but managing that externally created sales campaign is desired. An embodiment of a HELIOS™ system API allows third party users to do the following to support third party campaign usage:
1. Add/Update leads.
11. Register/Check into events.
111. Get list of calendar events.
1v. Get team members for an ICM.
v. Get current user information.
v1. Get lead information including notes, activity, communication, etc.

Another useful feature of the HELIOS™ system is an integrated hypertext markup language (HTML) editor. The HTML editor feature provides the administrator with the ability to create web pages to be used as part of funnels or campaigns. The editor may be integrated with HELIOS™ products, the event calendar and video content. This feature allows content creation to be shifted away from a development team and fully into the hands of a content team.

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of a user interface or window for use with the present invention. Finally, terms of degree such as “substantially”, “about” and “approximately” as used herein mean a reasonable amount of deviation of the modified term such that the end result is not significantly changed.

It will further be understood that the present invention may suitably comprise, consist of, or consist essentially of the component parts, method steps and limitations disclosed herein. However, the invention illustratively disclosed herein suitably may be practiced in the absence of any element which is not specifically disclosed herein.

While the foregoing advantages of the present invention are manifested in the detailed description and illustrated embodiments of the invention, a variety of changes can be made to the configuration, design and construction of the invention to achieve those advantages. Hence, reference herein to specific details of the structure and function of the present invention is by way of example only and not by way of limitation.

1-23. (canceled)

24. A computer implemented-method, the steps comprising:
registering a user in a system;
generating, by the system, a link for the user;
wherein the link is associated with a representative;
sending the link to the user;
receiving, from the user, interaction with the personalized link;
determining whether the user has a protected status;
when the user does not have a protected status, generating, by the system, a protected status for the user;
wherein the protected status is associated with the representative.

25. The method of claim 24, the steps further comprising when the user has a protected status, keeping the protected status associated with the same representative.

26. The method of claim 24, further comprising:
determining a release criteria customizable by the system;
determining whether the user has met the release criteria;
when the user has met the release criteria, removing the protected status of the user.

27. The method of claim 26, wherein the release criteria is a time period defined by the system.

28. The method of claim 26, wherein the release criteria is an interaction threshold.

29. The method of claim 26, wherein the release criteria is a milestone threshold.

30. The method of claim 24, wherein the link comprises a personalized link generated by the system according to information about the user.

31. The method of claim 24, wherein the link comprises an event invitation, wherein the event is determined according to information about the user.

32. The method of claim 26, further comprising while the user has not met the release criteria:
determining a time period set by the system, and
according to the time period, sending the user a notification.

33. The method of claim 24, wherein all sales generated from the user are associated with the representative associated with the protected status.

34. A system comprising a processor and a non-transitory computer-readable storage medium containing programming instructions thereon that when executed cause the system to:
register a user in a system;
generate, by the system, a link for the user;
wherein the link is associated with a
representative; send the link to the user;
receive, from the user, interaction with the personalized link;
determine whether the user has a protected status;
when the user does not have a protected status, generate, by the system, a protected status for the user;
wherein the protected status is associated with the representative.

35. The system of claim 34, wherein the programming instructions further cause the system to:
when the user has a protected status, keep the protected status associated with the same representative.

36. The system of claim 34, wherein the instructions further cause the system to: determine a release criteria customizable by the system;
determine whether the user has met the release criteria;
when the user has met the release criteria, remove the protected status of the user.

37. The system of claim 36, wherein the release criteria is a time period defined by the system.

38. The system of claim 36, wherein the release criteria is an interaction threshold.

39. The system of claim 36, wherein the release criteria is a milestone threshold.

40. The system of claim 34, wherein the link comprises a personalized link generated by the system according to information about the user.

41. The system of claim 34, wherein the link comprises an event invitation, wherein the event is determined according to information about the user.

42. The system of claim 36, wherein the programming instructions further cause the system to:
determine a time period set by the system, and
when the user has not met the release criteria, send the user a notification according to the time period.

43. The system of claim 34, wherein all sales generated from the user are associated with the representative associated with the protected status.
